(19) United States
(12) Patent Application Publication
(10) Pub. No.: US 2026/0296706 A1
(43) Pub. Date: Oct. 1, 2026

(54) Drug Package Separation Device

(71) Applicant: YUYAMA MFG. CO., LTD., Osaka (JP)

(72) Inventor: Norifumi OIKE, Osaka (JP)

(73) Assignee: YUYAMA MFG. CO., LTD., Osaka (JP)

(21) Appl. No.: 19/490,061

(22) PCT Filed: Jun. 5, 2024
(86) PCT No.: PCT/JP2024/020455

§ 371 Date: Dec. 4, 2025

(30) Foreign Application Priority Data
Jun. 7, 2023 (JP) 2023-094221
May 31, 2024 (JP) 2024-088779

(51) Int. Cl. B65B 61/12; A61J 1/03

(52) U.S. Cl. CPC B65B 61/12; A61J 1/035

(57) ABSTRACT

In order to provide a drug package separating apparatus that individually separates drug packages from a drug packaging strip in which the drug packages are connected in a band shape, provided is a drug package separating apparatus (1), which is configured to individually separate drug packages (110) from a drug packaging strip (120) in which the drug packages (110) are connected in a band shape. The drug package separating apparatus includes: a pair of abutment portions (51a, 51b) that are brought into contact with the same surface of the drug packaging strip (120); an abutment piece (35, 36) having one of the abutment portions (51a, 51b); and pressing means for pressing the abutment piece (35, 36) against the drug packaging strip (120). A force with which the pressing means presses the abutment piece (35) causes the abutment piece (35, 36) to move or change a posture of the abutment piece (35, 36) so that a distance between the abutment portions (51a, 51b) is increased.

### TECHNICAL FIELD

The present invention relates to a drug package separating apparatus that individually separates drug packages from a drug packaging strip in which the drug packages are connected in a band shape.

### BACKGROUND ART

There has been known a drug packaging apparatus that individually packages drugs such as tablets and powder medicines for each dose in accordance with a prescription.

For example, a drug packaging apparatus 100 as disclosed in Patent Literature 1 includes: drug packaging paper sheet holding means 102 for holding a packaging paper sheet 101 (drug packaging paper sheet) in a roll shape; a hopper 103; and a bag forming device 105, as illustrated in FIG. 17(a).

The drug packaging apparatus 100 is an apparatus that folds the packaging paper sheet 101 in two portions, and brings the portions of the folded packaging paper sheet 101 into close contact with each other by pressing, fusing, or the like so as not to be separated from each other, to thereby form a bag shape. Then, after a drug is introduced from the hopper 103 into a portion between the inner surfaces of the folded packaging paper sheet 101, a periphery of the portion into which the drug has been introduced is closed (sealed) to thereby produce a drug package 110.

In the drug packaging apparatus, as illustrated in FIG. 17, a plurality of drug packages are discharged as a drug packaging strip 120 in which the drug packages are connected in a band shape.

The drug packaging strip 120 includes a plurality of accommodating portions 121, in which drugs are allowed to be accommodated, and which are continuously provided via joining regions 122. On one side of the drug packaging strip 120, there is provided a common seal portion 125 in which long sides of the packaging paper sheet 101 are overlapped with each other to be fused. The joining region 122 is formed by overlapping and fusing intermediate portions of the packaging paper sheet 101.

The joining region 122 of the drug packaging strip 120 has a perforation 126. The perforation 126 is a separation line with low strength. The perforation 126 extends in a width direction of the drug packaging strip 120, and is formed in a region corresponding to the accommodating portion 121. The perforation 126 does not reach the common seal portion 125, and the common seal portion 125 is a seal portion 130 having no Separation line.

That is, the perforation (weak separation line) 126 is formed from a portion 131 corresponding to a bottom of the bag to immediately before the common seal portion 125, and the common seal portion 125 has no perforation 126.

In the related art, drug packages have been manually separated from the drug packaging strip 120. That is, the joining region 122 has been manually divided along the perforation 126 so that the drug packages 110 have been individually separated from the drug packaging strip 120.

### CITATION LIST

### Patent Literature

[PTL 1] JP 2022-47090 A
[PTL 2] JP 2022-176357 A

### SUMMARY OF INVENTION

### Technical Problem

As described above, in the related art, the drug packages 110 have been manually separated individually from the drug packaging strip 120. However, this separating operation is troublesome, and hence automation of this operation has been desired.

The present invention has been made in order to meet such a demand, and an object of the present invention is to provide a drug package separating apparatus that individually separates drug packages from a drug packaging strip in which the drug packages are connected in a band shape.

### Solution to Problem

In order to achieve the above-mentioned object, according to an aspect of the present invention, there is provided a drug package separating apparatus, which is configured to individually separate drug packages from a drug packaging strip in which the drug packages are connected in a band shape, the drug package separating apparatus including: a pair of abutment portions that are brought into contact with the same surface of the drug packaging strip; an abutment piece having one of the abutment portions; and pressing means for pressing the abutment piece against the drug packaging strip. A force with which the pressing means presses the abutment piece causes the abutment piece to move or change a posture of the abutment piece so that a distance between the abutment portions is increased.

The drug package separating apparatus of this aspect includes the pair of abutment portions that are brought into contact with the drug packaging strip. It is desired that the pair of abutment portions be set so as to be brought into contact with the same surface of the drug packaging strip across a perforation of the drug packaging strip, although not limited thereto. In the drug package separating apparatus of this aspect, the distance between the abutment portions is increased while the abutment portions are in contact with the drug packaging strip. Accordingly, the drug packaging strip is urged in a direction of separating the drug packages from each other. As a result, the drug packaging strip is pulled right and left across the perforation to be torn along the perforation.

Further, in the drug package separating apparatus of this aspect, the force with which the pressing means presses the abutment piece causes the abutment piece to move or change the posture of the abutment piece so that the distance between the abutment portions is increased, resulting in that no power is required for increasing the distance between the abutment portions.

In the above-mentioned aspect, it is desired that the drug package separating apparatus further include a pair of the abutment pieces, and when the pair of abutment pieces are pressed against the drug packaging strip by the pressing means, the pair of abutment pieces move or change the postures of the pair of abutment pieces so that the distance between the abutment portions is increased.

The drug package separating apparatus of this aspect includes abutment pieces as a pair. In this aspect, the pair of abutment pieces respectively move or change the postures thereof so that the distance between the abutment portions is increased.

In each of the above-mentioned aspects, it is desired that the drug package separating apparatus include a pair of abutment pieces, the abutment pieces include the abutment portions, the drug package separating apparatus include pressing means for pressing the abutment pieces against the drug packaging strip, and a force with which the pressing means presses the abutment pieces cause the abutment pieces to move or change postures thereof so that the distance between the abutment portions is increased.

According to this aspect, no power is required for increasing the distance between the abutment portions.

In each of the above-mentioned aspects, it is desired that the drug package separating apparatus include: a pair of abutment pieces having the abutment portions, the abutment portions being urged by an elastic member in a direction of approaching each other; and pressing means for pressing the abutment pieces against the drug packaging strip, and a force with which the pressing means presses the abutment pieces cause the abutment pieces to move or change the postures of the abutment pieces against the elastic member so that the distance between the abutment portions is increased.

According to this aspect, no power is required for increasing the distance between the abutment portions.

In each of the above-mentioned aspects, it is desired that the abutment portions turn about a turn shaft, the abutment portions be located at positions offset with respect to the turn shaft, and the abutment portions move due to a force with which the abutment portions are pressed against the drug packaging strip.

According to this aspect, a component of force in a lateral direction is generated at the abutment portions on the drug packaging strip, and the distance between the abutment portions is increased. For example, when a configuration is adopted in which the drug packaging strip is conveyed so that a position to be separated is arranged between the abutment portions, a component of force directed upstream or downstream in the conveyance direction of the drug packaging strip is generated at the abutment portions. Accordingly, the distance between the abutment portions is increased.

As a result, the drug packaging strip is torn into an upstream portion and a downstream portion.

In each of the above-mentioned aspects, it is desired that the abutment portions each have a length corresponding to at least a width of the drug packaging strip.

According to this aspect, the drug package can be completely separated.

In each of the above-mentioned aspects, it is desired that the abutment portions each have a certain length, and a distance between the abutment portions at normal time and/or a distance between the abutment portions at the time when the distance has been increased differ in a longitudinal direction of the abutment portions.

In the drug package separating apparatus of this aspect, the drug packaging strip is first torn at a portion at which the distance between the abutment portions is wide, and a region to be separated gradually expands. Accordingly, a pulling force is not dispersed, and hence the drug package can be separated with a small force.

Further, in the drug package separating apparatus of this desired that the drug package separating apparatus include: a separating unit and a feeding device, the separating unit including the pair of abutment portions, the feeding device being configured to move the drug packaging strip toward the separating unit; and retaining means for retaining the drug packaging strip, the retaining means being provided on an upstream side of the separating unit.

The drug package separating apparatus of this aspect includes a feeding device, and the feeding device moves the drug packaging strip toward the separating unit. In the drug package separating apparatus of this aspect, the retaining means for retaining the drug packaging strip is provided on the upstream side of the separating unit. Accordingly, the drug packaging strip is less liable to rise, and hence is smoothly cut.

In each of the above-mentioned aspects, it is desired that the drug packaging strip have a separation line with low strength, and the drug packages be allowed to be individually separated along the separation line, the drug package separating apparatus include a feeding device, and the feeding device be configured to move the drug packaging strip so that a position of the separation line matches a position between the pair of abutment portions.

According to this aspect, with the separation line of the drug packaging strip being arranged between the pair of abutment portions, the drug packaging strip is pulled by the pair of abutment portions across the separation line. Accordingly, the drug packaging strip is smoothly cut.

In each of the above-mentioned aspects, it is desired that the drug package separating apparatus include a protruding piece that is brought into contact with the drug packaging strip, and the protruding piece be configured to urge a part of the drug packaging strip.

In the drug package separating apparatus of this aspect, the distance between the abutment portions is increased while the abutment portions are in contact with the drug packaging strip. Accordingly, the drug packaging strip is urged in a direction of separating the drug packages from each other. As a result, the drug packaging strip is pulled right and left across the perforation to be torn along the perforation.

Further, the drug package separating apparatus of this aspect includes the protruding piece, and a part of the drug packaging strip is urged by the protruding piece. Accordingly, a starting point for tearing is formed in a part of the drug packaging strip by the protruding piece. As a result, even when there is a seal portion without a perforation, cutting of the drug packaging strip begins and proceeds from the starting point, and thus the drug package is separated from the drug packaging strip.

In each of the above-mentioned aspects, it is desired that a cut be formed in a part of the drug packaging strip by the protruding piece.

The drug package separating apparatus of this aspect includes the protruding piece, and a cut is formed in a part of the drug packaging strip by the protruding piece. In other words, a cut that becomes a starting point for tearing is formed in a part of the drug packaging strip by the protruding piece. Accordingly, even when there is a seal portion without a perforation, cutting of the drug packaging strip begins and proceeds from the cut formed by the protruding piece, and thus the drug package is separated from the drug packaging strip.

In the above-mentioned aspect, it is desired that the protruding piece be provided between the pair of abutment portions.

As described above, it is desired that the pair of abutment portions be set so as to be brought into contact with the same surface of the drug packaging strip across the perforation of the drug packaging strip. In the drug package separating apparatus of this aspect, the protruding piece is provided between the abutment portions, and hence the protruding piece is on the perforation or on an extension line of the perforation. Accordingly, even when there is a seal portion without a perforation, cutting of the drug packaging strip begins and proceeds from the cut formed by the protruding piece, and thus the drug package is separated from the drug packaging strip.

In each of the above-mentioned aspects, it is desired that the protruding piece have a plate shape with a pointed tip.

According to this aspect, with the protruding piece having the pointed tip, a cut is easily made in the drug packaging strip. Further, at the time of tearing the drug packaging strip, the drug packaging strip can be neatly torn from a portion pressed by the protruding piece as a beginning of the tearing.

In each of the above-mentioned aspects, it is desired that the abutment portions each have a length corresponding to at least a width of the drug packaging strip, and the protruding piece be provided in the vicinity of end portions of the abutment portions.

According to this aspect, even when there is a seal portion, a cut is made in the seal portion or in the vicinity thereof by the protruding piece. Accordingly, cutting of the drug packaging strip begins and proceeds from the cut, and thus the drug package is separated from the drug packaging strip.

In each of the above-mentioned aspects, it is desired that the drug packaging strip include: a plurality of accommodating portions, each of which is configured to accommodate a drug, and which are continuously provided via joining regions, the joining regions each having a separation line with low strength, the separation line extending in a width direction of the drug packaging strip; and a seal portion being free of the separation line, which is formed in the vicinity of an end portion in the width direction of the drug packaging strip, and the protruding piece be provided at a position at which the protruding piece is brought into contact with at least a part of the seal portion.

According to this aspect, a cut is made in the seal portion by the protruding piece. Accordingly, cutting of the drug packaging strip begins and proceeds from the cut, and thus the drug package is separated from the drug package strip.

In each of the above-mentioned aspects, it is desired that the drug package separating apparatus include: a reel accommodating region in which a plurality of reels, on each of which a drug packaging strip has been wound, are allowed to be installed; a separating unit, which is provided with abutment portions, and is configured to separate a drug package from the drug packaging strip supplied from the reel; and conveyance means for conveying the drug package separated by the separating unit, the reel accommodating region be provided above the separating unit, and the conveyance means be provided below the separating unit.

The drug package separating apparatus of this aspect includes the reel accommodating region, and the plurality of reels on each of which the drug packaging strip has been wound are installed in the reel accommodating region. Accordingly, for example, drug packages for a plurality of patients can be mounted at one time, and operations can be continuously performed.

According to the drug package separating apparatus of this aspect, the drug package separated by the separating unit can be conveyed by the conveyance means.

The drug package separating apparatus of this aspect has a structure in which portions having individual functions are stacked in a vertical direction, and thus an occupied area is small.

In each of the above-mentioned aspects, it is desired that the separating unit be movable, and be allowed to move to a lower side of any appropriate reel.

According to this aspect, a plurality of reels can be selected, and the drug packaging strip wound on each of the reels can be separated into individual drug packages.

In each of the above-mentioned aspects, it is desired that the conveyance means hold the drug package to move linearly, and release the drug package at a predetermined position.

According to this aspect, the drug package can be moved to a predetermined position.

In each of the above-mentioned aspects, it is desired that the drug package separating apparatus include: a holding member configured to hold one side of the drug package; and posture changing means for changing a posture of the holding member, and the drug package be held in a vertical posture by the holding member, and then the posture of the drug package be changed to a horizontal posture by the posture changing means.

According to this aspect, the drug package can be moved to a predetermined position.

In each of the above-mentioned aspects, it is desired that the drug package separating apparatus include warpage removing means for continuously bending a part of the drug packaging strip.

According to this aspect, warpage of the drug packaging strip can be removed.

In each of the above-mentioned aspects, it is desired that the warpage removing means include: a roller having a protruding ridge on a peripheral surface thereof; and a roller having a recessed groove in a peripheral surface thereof.

According to this aspect, warpage of the drug packaging strip can be continuously removed.

### Advantageous Effects of Invention

According to the drug package separating apparatus of the present invention, the drug packages can be individually separated from the drug packaging strip in which the drug packages are connected in a band shape, without manual operation.

### BRIEF DESCRIPTION OF DRAWINGS

FIG. 1 is a perspective view of a drug package separating apparatus according to an embodiment of the present invention.

FIG. 2 is a front view of the drug package separating apparatus of FIG. 1.

FIG. 3 is an exploded perspective view of the drug package separating apparatus of FIG. 1.

FIG. 4 is a mechanism view of a feeding device of the drug package separating apparatus of FIG. 1.

FIG. 5 is a perspective view of a separating unit of the drug package separating apparatus of FIG. 1, as observed from a discharge side of a drug packaging strip.

FIG. 6 is a perspective view of the separating unit of the drug package separating apparatus of FIG. 1, as observed from an entry side of the drug packaging strip.

FIG. 7 are each a mechanism view of the separating unit of the drug package separating apparatus of FIG. 1, in which FIG. 7(a) shows a state in which upper and lower abutment piece pairs are separated from each other, and FIG. 7(b) shows a state in which the upper and lower abutment piece pairs are in contact with each other.

FIG. 8 is a mechanism view of a discharging device of the drug package separating apparatus of FIG. 1.

FIG. 9(a) and FIG. 9(b) are perspective views of the upper and lower abutment piece pairs.

FIG. 10 is a perspective view of the upper abutment piece pair.

FIG. 11 are a plan view of the upper abutment piece pair and a sectional view thereof taken along the line A-A, in which

FIG. 11(a) shows a state in which a distance between abutment pieces is narrow, and FIG. 11(b) shows a state in which the distance between the abutment pieces is increased.

FIG. 12 is an exploded perspective view of the upper abutment piece pair.

FIG. 13(a) is an exploded perspective view of an abutment piece, and FIG. 13(b) is a sectional view of a main body portion of the abutment piece.

FIG. 14 is an explanatory view for illustrating a first stage and a second stage at the time when the drug packaging strip is being separated, in which a center part of FIG. 14 is a front view for illustrating a state of the upper and lower abutment piece pairs, a left part of FIG. 14 shows a state of the drug packaging strip at that time, and a right part of FIG. 14 is a plan view for illustrating a state of the upper and lower abutment piece pairs at that time.

FIG. 15 is an explanatory view for illustrating a third stage and a fourth stage at the time when the drug packaging strip is being separated, in which a center part of FIG. 15 is a front view for illustrating a state of the upper and lower abutment piece pairs, a left part of FIG. 15 shows a state of the drug packaging strip at that time, and a right part of FIG. 15 is a plan view for illustrating a state of the upper and lower abutment piece pairs at that time.

FIG. 16 are each an explanatory view for illustrating a method of positioning the drug packaging strip.

FIG. 17(a) is an explanatory view for illustrating a main part of a drug packaging apparatus, FIG. 17(b) is a front view of a drug packaging strip and drug packages, and FIG. 17(c) is an enlarged view of a part of the drug packaging strip.

FIG. 18 is a perspective view of a drug package separating apparatus according to another embodiment of the present invention.

FIG. 19 is a perspective view of the drug package separating apparatus of FIG. 18, illustrating a state in which an upper drawer and a lower drawer are pulled out.

FIG. 20 is a front view for illustrating an internal structure of a drug dispensing apparatus of FIG. 18.

FIG. 21 is a side view for illustrating the internal structure of the drug dispensing apparatus of FIG. 18.

FIG. 22 is a front view for illustrating the internal structure of the drug dispensing apparatus of FIG. 18, in a state of being separated into a cassette accommodating region, a separating region, and a distributing region.

FIG. 23 is a side view for illustrating the internal structure of the drug dispensing apparatus of FIG. 18, in a state of being separated into the cassette accommodating region, the separating region, and the distributing region.

FIG. 24 is a perspective view for illustrating the internal structure of the drug dispensing apparatus of FIG. 18.

FIG. 25 is a perspective view for conceptually illustrating a mechanism and arrangement of main members in the internal structure of the drug dispensing apparatus of FIG. 18.

FIG. 26(a) is a perspective view for illustrating a state in which a cassette tray and a roll cassette are separated from each other in the cassette accommodating region, FIG. 26(b) is a perspective view for illustrating a state in which the roll cassette is mounted on the cassette tray, as observed from one direction, and FIG. 26(c) is a perspective view for illustrating a state in which the roll cassette is mounted on the cassette tray, as observed from a side opposite to the side in FIG. 26(b) from which the state is observed.

FIG. 27 is a perspective view of the roll cassette and a driving device that drives the roll cassette.

FIG. 28 is a mechanism view of the roll cassette.

FIG. 29 is a front view for illustrating a passage path of the drug packaging strip in the roll cassette.

FIG. 30 is a perspective view for illustrating a state in which the drug packaging strip is passing through a warpage removing roller pair, in which FIG. 30(a) shows a state in which a leading edge of the drug packaging strip is present in the vicinity of the warpage removing roller pair, and FIG. 30(b) shows a state in which the leading edge of the drug packaging strip is sandwiched by the warpage removing roller pair.

FIG. 31 is a front view for illustrating a state in which the leading edge of the drug packaging strip is bit into the warpage removing roller pair.

FIG. 32(a) is a sectional view taken along the line A-A of FIG. 31, FIG. 32(b) is a perspective view of the drug packaging strip before passing through the warpage removing roller pair, and FIG. 32(c) is a perspective view of the drug packaging strip after passing through the warpage removing roller pair.

FIG. 33 is a perspective view for illustrating a state in which the separating region and the distributing region of the drug dispensing apparatus of FIG. 18 are separated from each other.

FIG. 34 is a perspective view for conceptually illustrating the distributing region of the drug dispensing apparatus of FIG. 18.

FIG. 35 is an exploded perspective view for conceptually illustrating a multifunctional block in the distributing region of the drug dispensing apparatus of FIG. 18.

FIG. 36 are each a mechanism view of the multifunctional block of FIG. 35, in which FIG. 36(a) shows a state at the time of receiving the drug packaging strip, FIG. 36(b) shows a state in which a posture of the drug packaging strip is changed downward, and FIG. 36(c) shows a state at the time when the drug packaging strip is released.

FIG. 37 is a mechanism view of a dispensing unit of the multifunctional block of FIG. 35.

FIG. 38 are each an explanatory view for illustrating a coordinated operation of a receiving unit and the dispensing unit, in which FIG. 38(a) shows a front view and a side view of a first stage, and FIG. 38(b) shows a front view and a side view of a second stage.

FIG. 39 are each an explanatory view for illustrating the coordinated operation of the receiving unit and the dispensing unit, in which FIG. 39(c) shows a front view and a side view of a third stage, and FIG. 39(d) shows a front view and a side view of a fourth stage.

FIG. 40 are each an explanatory view for illustrating the coordinated operation of the receiving unit and the dispensing unit, in which FIG. 40(e) shows a front view and a side view of a fifth stage, and FIG. 40 (f) shows a front view and a side view of a sixth stage.

FIG. 41(a) is a perspective view for illustrating a state in which a distribution box and a drug setting tool are separated from each other, and FIG. 41(b) is a perspective view for illustrating a state in which the drug setting tool is mounted in the distribution box.

### DESCRIPTION OF EMBODIMENTS

Now, a first embodiment of the present invention is described.

A drug package separating apparatus 1 of this embodiment is used alone or under a state of being incorporated in other equipment.

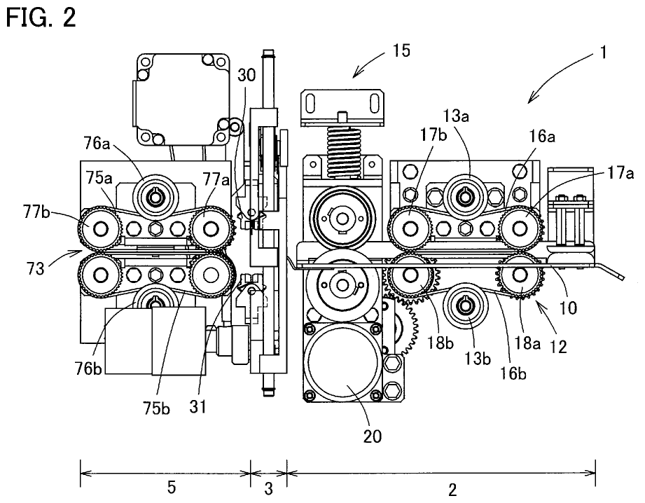

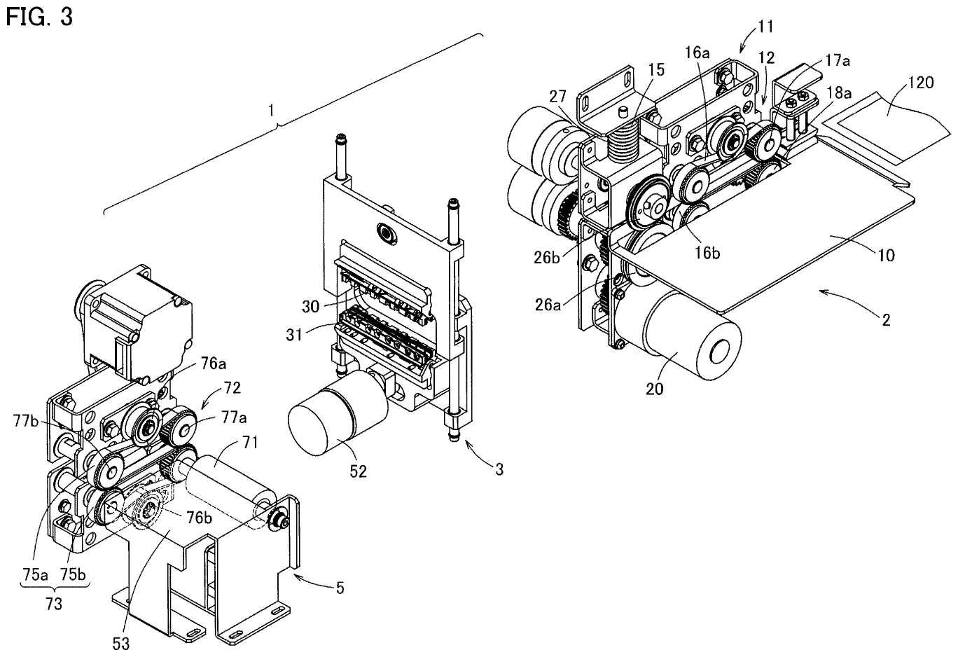

As illustrated in FIG. 2 and FIG. 3, the drug package separating apparatus 1 includes a feeding device 2, a separating unit 3, and a discharging device 5. Each of those components is individually described below.

### Feeding Device 2

The feeding device 2 includes a conveyance path member 10 and a feeding mechanism 11.

The conveyance path member 10 is a metal plate, and serves as a table on which a drug packaging strip 120 is to be placed and slid.

The feeding mechanism 11 includes a conveyance mechanism unit 12 and a retaining portion 15.

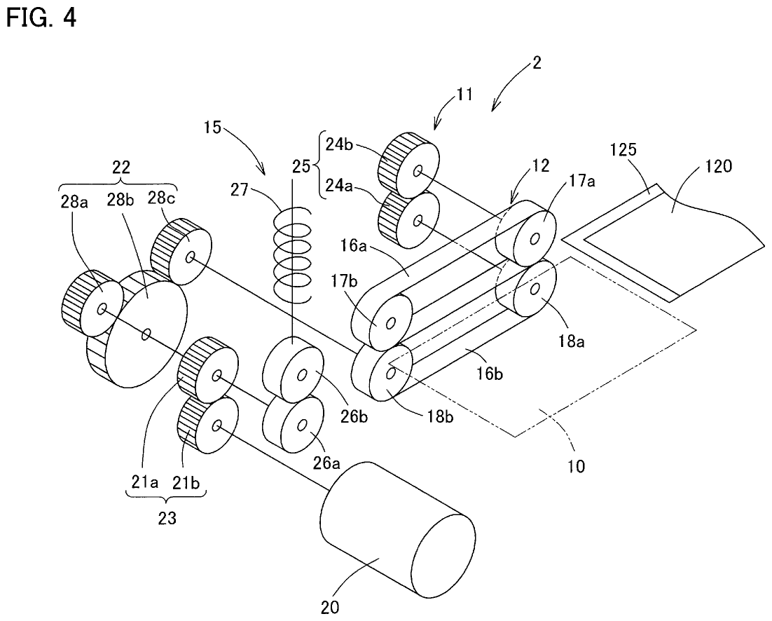

As illustrated in FIG. 3 and FIG. 4, the conveyance mechanism unit 12 includes a pair of an upper conveyance belt 16a and a lower conveyance belt 16b, and moves the drug packaging strip 120 by sandwiching one side of the drug packaging strip 120 between the conveyance belts 16a and 16b.

The conveyance belts 16a and 16b are respectively stretched between a pair of pulleys 17a and 17b and a pair of pulleys 18a and 18b. Tension pulleys 13a and 13b are provided outside stretch paths of the conveyance belts 16a and 16b (not illustrated in FIG. 4).

The conveyance mechanism unit 12 moves the drug packaging strip 120 by sandwiching one side of the drug packaging strip 120 between the conveyance belt 16a stretched between the pair of pulleys 17a and 17b, and the conveyance belt 16b stretched between the pair of pulleys 18a and 18b.

The retaining portion 15 includes a pair of an upper roller 26b and a lower roller 26a. The lower roller 26a is rotated by power, and the upper roller 26b is freely rotatable and is pressed against the lower roller 26a by a spring 27.

In the feeding mechanism 11, a geared motor 20 is arranged below the conveyance path member 10, and a rotational force of the geared motor 20 drives the conveyance belts 16a and 16b and the lower roller 26a of the retaining portion 15.

That is, the rotational force of the geared motor 20 is transmitted to a gear train 23 including gears 21a and 21b. Then, the rotational force of one gear 21a of the gear train 23 is transmitted to the lower roller 26a of the retaining portion 15. Further, the rotational force of the gear 21a is transmitted to the conveyance belts 16a and 16b via a gear train 22.

That is, the rotational force of the gear 21a is transmitted directly to the lower roller 26a of the retaining portion 15.

Meanwhile, power is transmitted to the conveyance belts 16a and 16b via the gear train 22 including gears 28a, 28b, and 28c.

That is, the power is transmitted from the gear 28c of the gear train 22 to the pulley 18b on the lower side. Further, the rotational force of the pulley 18a is transmitted to the pulley 17a on the upper side via a gear train 25 including gears 24a and 24b.

Accordingly, when the geared motor 20 is driven, a lower surface of the upper conveyance belt 16a and an upper surface side of the lower conveyance belt 16b advance in the same direction.

In the feeding device 2, the conveyance path member 10 is arranged so as to be in a substantially parallel posture, and the feeding mechanism 11 is arranged on one side thereof. Further, the retaining portion 15 is provided at a most downstream position.

The feeding device 2 is a device that feeds the drug packaging strip 120 to the separating unit 3 side. In the feeding device 2, the drug packaging strip 120 is placed on the conveyance path member 10, and a common seal portion 125 of the drug packaging strip 120 is sandwiched between the pair of the upper conveyance belt 16a and the lower conveyance belt 16b. Then, the geared motor 20 is driven so that the conveyance belts 16a and 16b travel. Along with the travel of the conveyance belts 16a and 16b, the drug packaging strip 120 sandwiched therebetween is fed to the separating unit 3 side.

Further, in this embodiment, the drug packaging strip 120 is fed by an amount corresponding to one drug package 110.

### Separating Unit 3

The separating unit 3 is a unit that separates the drug package 110 from the drug packaging strip 120.

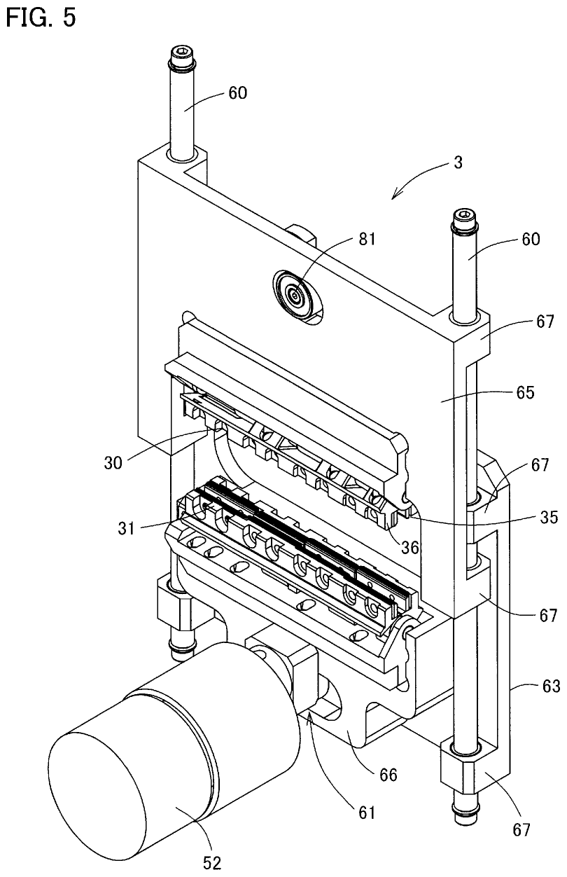

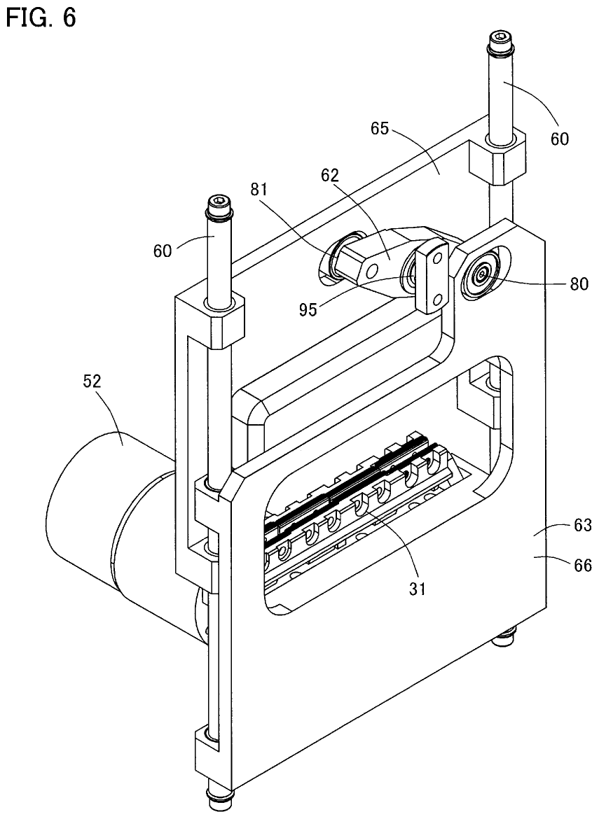

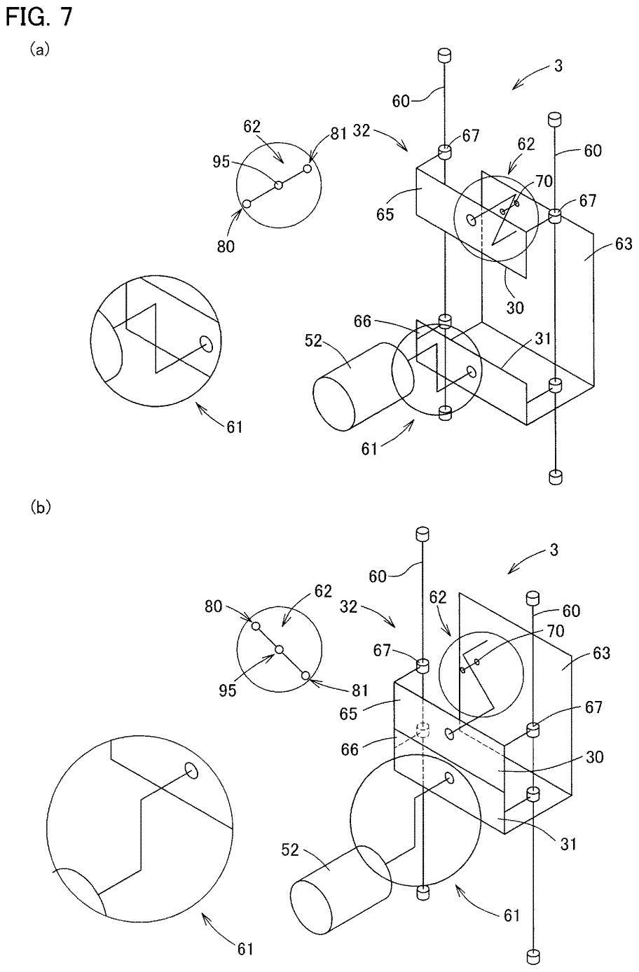

As illustrated in FIG. 5, FIG. 6, and FIG. 7, the separating unit 3 includes a one-side abutment piece pair 30, an another-side abutment piece pair 31, and a lifting mechanism 32 that moves up and down the one-side abutment piece pair 30 and the another-side abutment piece pair 31.

In this embodiment, the drug packaging strip 120 is conveyed in a horizontal direction and the one-side abutment piece pair 30 is located above the drug packaging strip 120, and hence the one-side abutment piece pair 30 is referred to as “upper abutment piece pair 30” in the following description. Similarly, the another-side abutment piece pair 31 is referred to as “lower abutment piece pair 31.”

### Abutment Piece Pairs 30 and 31

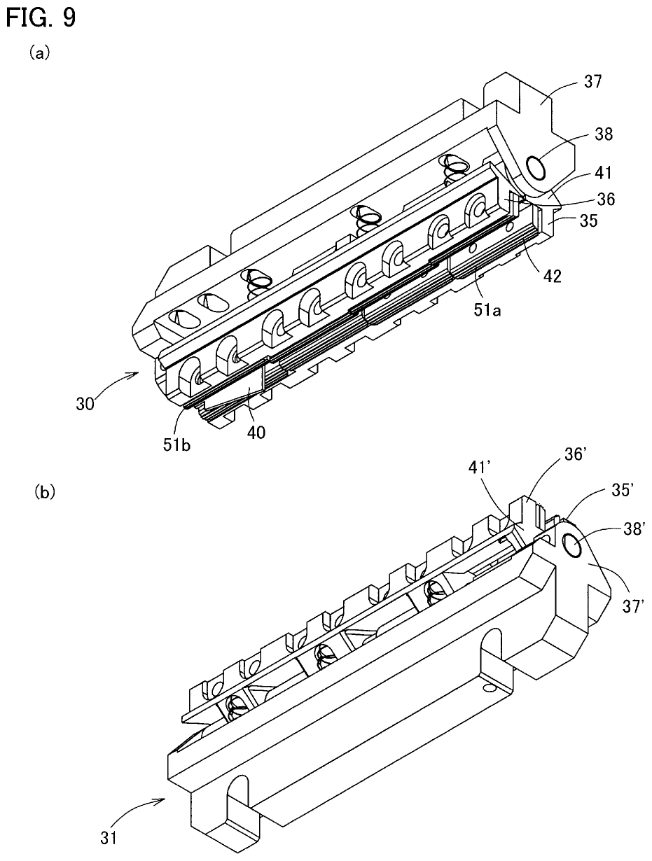

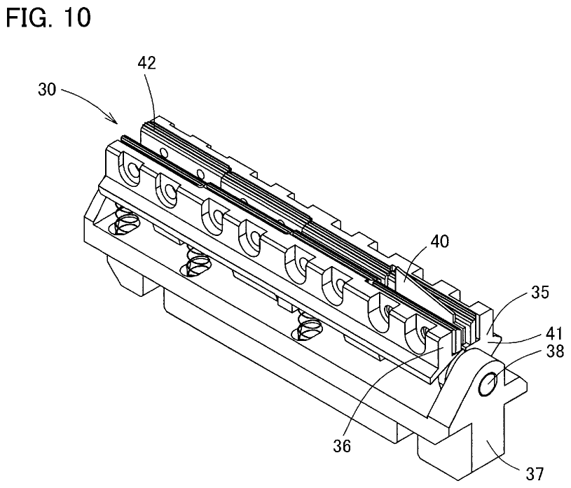

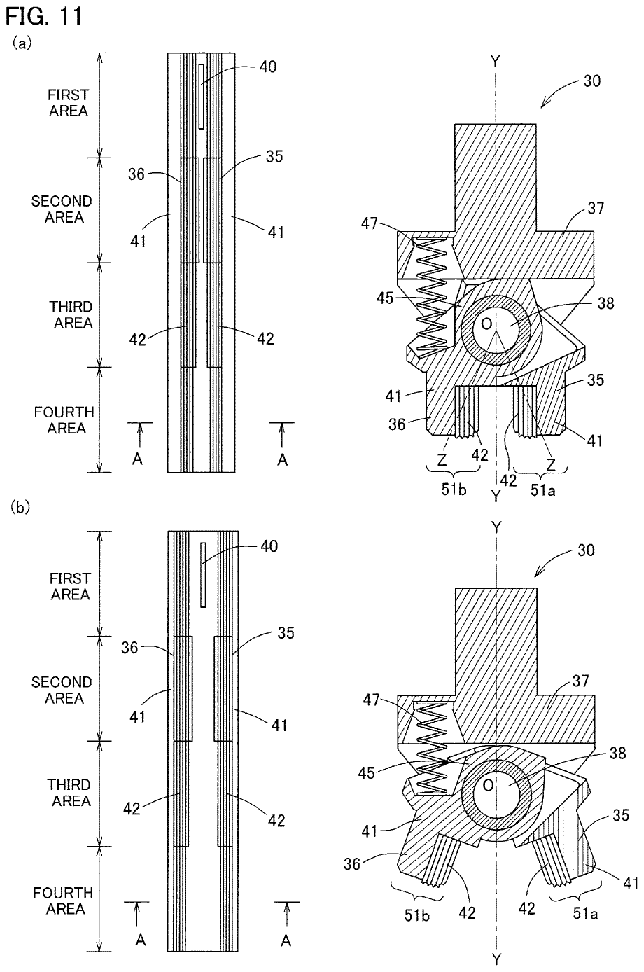

As illustrated in FIG. 9, FIG. 10, and FIG. 11, the upper abutment piece pair 30 includes a right abutment piece 35, a left abutment piece 36, a protruding piece 40, and a pedestal portion 37. The pedestal portion 37 includes a common shaft 38, and the right abutment piece 35 and the left abutment piece 36 are swingably attached to the common shaft 38. The protruding piece 40 is provided between the right abutment piece 35 and the left abutment piece 36 and on one end side thereof in a longitudinal direction.

It is desired that a position and a length of the protruding piece 40 be appropriately changed according to a width or the like of the drug packaging strip 120.

Now, each member is described. The right abutment piece 35 and the left abutment piece 36 are the same except that the right abutment piece 35 and the left abutment piece 36 are symmetrical, and hence the right abutment piece 35 is described in detail.

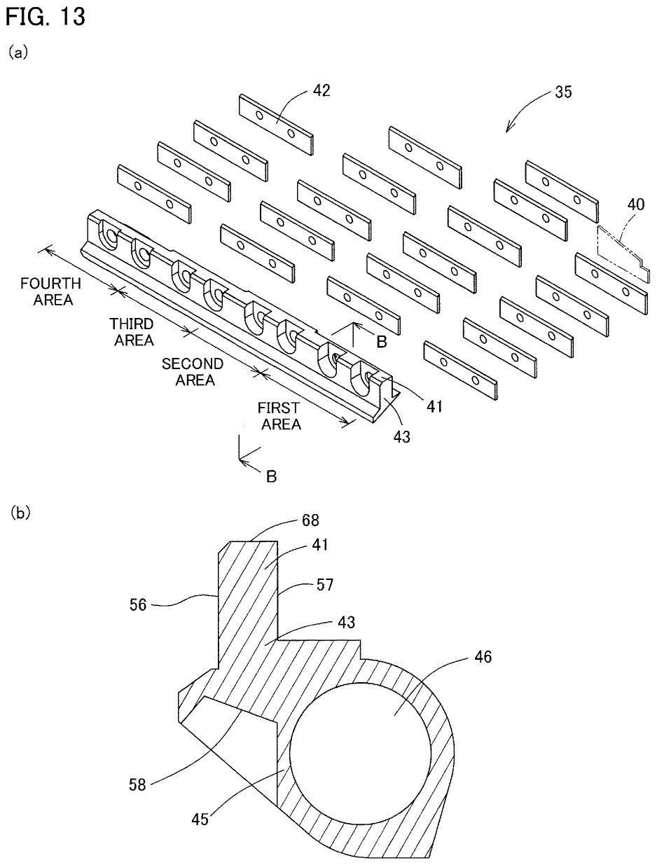

As illustrated in FIG. 13, the right abutment piece 35 includes a swing piece 41 and a plurality of thickness members 42.

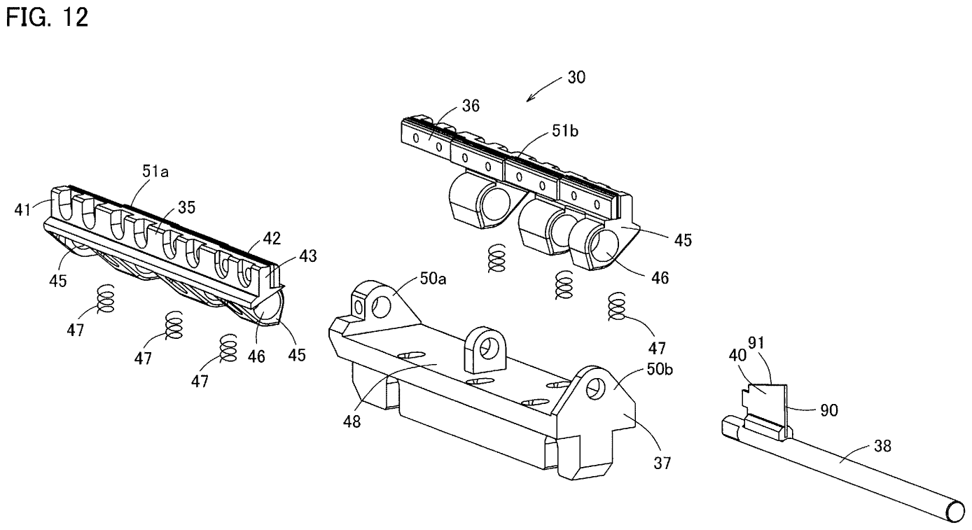

As illustrated in FIG. 12 and FIG. 13, the swing piece 41 includes a main body portion 43, and attachment portions 45 are provided at a plurality of positions on one surface of the main body portion 43. The main body portion 43 is an elongated bar-shaped portion.

A sectional shape of the main body portion 43 is as illustrated in FIG. 13(b), and the main body portion 43 includes an outer wall surface 56, an inner wall surface 57 facing the outer wall surface 56, a top wall surface 68, and an attachment portion placement surface 58.

The above-mentioned attachment portion 45 is formed on the attachment portion placement surface 58. As illustrated in FIG. 12, the attachment portions 45 are arranged linearly on one side of the main body portion 43. The attachment portion 45 has a through hole 46 through which the common shaft 38 is allowed to be inserted.

The thickness member 42 is a rectangular thin plate. The thickness member 42 is attached to the inner wall surface 57 of the main body portion 43 with a screw (not shown).

In this embodiment, as illustrated in FIG. 11 and FIG. 13, the main body portion 43 is divided into four areas in the longitudinal direction, and the number of thickness members 42 is different for each area. Further, in this embodiment, the thickness of the main body portion 43 itself is also different for each area.

That is, a second area has a large number of thickness members 42, and the number of stacked thickness members 42 decreases as proceeding to the subsequent areas. A first area is irregular, and the number of thickness members 42 is small in order to secure a space for the protruding piece 40 to enter, as described later.

As illustrated in FIG. 12, the pedestal portion 37 includes a pedestal main body 48 having a plate shape, and shaft support portions 50a and 50b are provided at both ends in a longitudinal direction of the pedestal main body 48. The common shaft 38 is supported by the shaft support portions 50a and 50b.

The protruding piece 40 is a plate-shaped member provided on the common shaft 38 and made of a hard material such as metal. The protruding piece 40 has a substantially trapezoidal front shape, and is a thin plate with a pointed tip portion. That is, the protruding piece 40 has a vertical line 90 and an inclined line 91 connected to the vertical line 90, and an intersection between the vertical line 90 and the inclined line 91 is sharply pointed.

In this embodiment, the thickness of the protruding piece 40 is uniform, but the inclined line 91 may be blade-shaped. Further, in this embodiment, each side of the protruding piece 40 is linear, but may be arc-shaped.

In the upper abutment piece pair 30, the common shaft 38 is inserted through the through holes 46 of the attachment portions 45 of the right abutment piece 35 and the left abutment piece 36. The right abutment piece 35 and the left abutment piece 36 are swingable with respect to the common shaft 38. Further, as illustrated in FIG. 11 and FIG. 12, the right abutment piece 35 and the left abutment piece 36 are urged by springs (elastic members) 47 in a direction of approaching each other. However, the right abutment piece 35 and the left abutment piece 36 do not approach each other beyond a certain limit.

A state in which the right abutment piece 35 and the left abutment piece 36 are attached to the pedestal portion 37 is as illustrated in FIG. 9, FIG. 10, and FIG. 11, and the thickness members 42 of the right abutment piece 35 and the thickness members 42 of the left abutment piece 36 are in a positional relationship of facing each other.

As described above, the main body portion 43 of each of the right abutment piece 35 and the left abutment piece 36 is divided into four areas in the longitudinal direction, and the number of stacked thickness members 42 decreases as proceeding to the areas subsequent to the second area. Further, as described above, the right abutment piece 35 and the left abutment piece 36 are urged by the springs (elastic members) 47 in the direction of approaching each other. Accordingly, as illustrated in FIG. 11, in an area with a large number of thickness members 42, a distance between the right abutment piece 35 and the left abutment piece 36 is narrow, and in an area with a small number of thickness members 42, the distance between the right abutment piece 35 and the left abutment piece 36 is wide.

In this embodiment, as illustrated in FIG. 11, the distance in the second area is the narrowest, and the distance in a fourth area is the widest.

In this embodiment, the thickness of the main body portion 43 of the swing piece 41 is different for each area, and the number of thickness members 42 is also different. In this embodiment, the distance between the right abutment piece 35 and the left abutment piece 36 is made different depending on the portion by changing both the thickness of the main body portion 43 and the number of thickness members 42, but the distance between the right abutment piece 35 and the left abutment piece 36 may be made different depending on the portion only by changing the thickness of the main body portion 43. Further, the distance between the right abutment piece 35 and the left abutment piece 36 may be made different depending on the portion only by changing the number of thickness members 42.

In this embodiment, one surface of the right abutment piece 35 and the entire one surface of the left abutment piece 36 serve as abutment portions 51a and 51b that are brought into contact with the drug packaging strip 120.

That is, the top wall surface 68 of the swing piece 41 of the right abutment piece 35 and side surfaces of the plurality of thickness members 42 function as the abutment portion 51a of the right abutment piece 35 that is brought into contact with the drug packaging strip 120. Similarly, the top wall surface 68 of the swing piece 41 of the left abutment piece 36 and side surfaces of the plurality of thickness members 42 function as the abutment portion 51b of the left abutment piece 36 that is brought into contact with the drug packaging strip 120.

The entire abutment portions 51a and 51b are inclined inward.

In this embodiment, the right abutment piece 35 and the left abutment piece 36 swing about the common shaft 38. Here, in this embodiment, as illustrated in FIG. 11, when a perpendicular line passing through the center of the common shaft 38 is represented by Y, and a straight line connecting the center of the common shaft 38 and each of the abutment portions 51a and 51b to each other is represented by Z, the straight line Z is inclined with respect to the perpendicular line Y. In other words, the right abutment portion 51a and the left abutment portion 51b are located at positions offset with respect to the perpendicular line Y passing through the center of the common shaft 38.

Accordingly, when the upper abutment piece pair 30 is pressed by hitting an object, a component of force in a lateral direction is generated on the right abutment portion 51a and the left abutment portion 51b, and the right abutment portion 51a and the left abutment portion 51b open as illustrated in FIG. 11(b).

Further, with the entire abutment portions 51a and 51b being inclined inward, even in a situation in which the abutment portions 51a and 51b are open, a part of each of the abutment portions 51a and 51b is brought into contact with the drug packaging strip 120. That is, in this embodiment, with the entire abutment portions 51a and 51b being inclined inward, contact between the abutment portions 51a and 51b and the drug packaging strip 120 is maintained from when the abutment portions 51a and 51b start opening until the abutment portions 51a and 51b finish the opening.

In the upper abutment piece pair 30, the protruding piece 40 is fixed between the right abutment piece 35 and the left abutment piece 36. The protruding piece 40 is provided in the first area in which the distance between the right abutment piece 35 and the left abutment piece 36 is narrow.

As in the second area, in the first area, the distance between the abutment portions 51a and 51b is narrow, and there is substantially no gap between the abutment portions 51a and 51b when the abutment portions 51a and 51b are closed through intermediation of the protruding piece 40.

In this embodiment, the protruding piece 40 is provided between the pair of abutment portions 51a and 51b. Further, the abutment portions 51a and 51b each have a length corresponding to at least the width of the drug packaging strip 120, and the protruding piece 40 is located at a position in the vicinity of end portions of the abutment portions 51a and 51b.

Next, the lower abutment piece pair 31 is described. The lower abutment piece pair 31 is the same as the above-mentioned upper abutment piece pair 30 except that the lower abutment piece pair 31 includes no protruding piece 40, and hence only simple description is given. In order to distinguish the members of the lower abutment piece pair 31 from the upper abutment piece pair 30, a prime mark “′” is added to the constituent members of the lower abutment piece pair 31. Some of the constituent members of the lower abutment piece pair 31 are not illustrated for the sake of drawing. Members that are not illustrated are indicated with parentheses, such as (42′). In the lower abutment piece pair 31, a right abutment piece 35′ and a left abutment piece 36′ are swingably attached to a common shaft 38′ of a pedestal portion 37′.

The right abutment piece 35′ and the left abutment piece 36′ have the same configuration except that the right abutment piece 35′ and the left abutment piece 36′ are symmetrical.

The right abutment piece 35′ includes thickness members (42′) attached to a swing piece 41′.

The swing piece 41′ includes attachment portions (45′) provided at a plurality of positions on a main body portion (43′). The main body portion (43′) is divided into four areas in the longitudinal direction, and a second area has a large number of thickness members 42, and the number of stacked thickness members decreases as proceeding to the subsequent areas.

The right abutment piece 35′ and the left abutment piece 36′ are swingable with respect to the common shaft 38′. Further, the right abutment piece 35′ and the left abutment piece 36′ are urged by springs (47) in a direction of approaching each other.

The thickness members (42′) of the right abutment piece 35′ and the thickness members (42′) of the left abutment piece 36′ are located at a position facing each other.

The entire one surface of the right abutment piece 35′ and the entire one surface of the left abutment piece 36′ serve as abutment portions 51′a and 51′b that are brought into contact with the drug packaging strip 120.

In this embodiment, the right abutment piece 35, 35′ and the left abutment piece 36, 36′ turn to change postures thereof, and a space between the right abutment piece 35, 35′ and the left abutment piece 36, 36′ opens, but the right abutment piece 35, 35′ and the left abutment piece 36, 36′ may move horizontally to open the space therebetween.

The swing piece 41 adopted in this embodiment includes the thickness members 42, and the distance between the right abutment piece 35 and the left abutment piece 36 is made different depending on the location by changing the number of thickness members 42 depending on the location, but the distance between the right abutment piece 35 and the left abutment piece 36 may be changed by changing the thickness of the thickness member 42 itself.

Further, the distance between the right abutment piece 35 and the left abutment piece 36 may be changed by changing the thickness of the swing piece 41 itself.

In this embodiment, with the stacking of the thickness members 4, a slip-preventing effect in the case of being brought into contact with the drug packaging strip 120 is obtained.

When the thickness member 4 is not used, it is recommended to perform a slip-preventing treatment such as roughening a distal end of the abutment portion 51.

### Lifting Mechanism 32

Next, the lifting mechanism 32 is described. The lifting mechanism 32 is a mechanism for moving the upper abutment piece pair 30 and the lower abutment piece pair 31 in an up-down direction to cause the upper abutment piece pair 30 and the lower abutment piece pair 31 to approach and separate from each other. The lifting mechanism 32 is pressing means for pressing the upper abutment piece pair 30 and the lower abutment piece pair 31 against the drug packaging strip 120.

The lifting mechanism 32 includes one geared motor 52 and a link mechanism, and moves up and down the upper abutment piece pair 30 and the lower abutment piece pair 31 by rotating the geared motor 52.

A mechanism portion of the lifting mechanism 32 is as illustrated in FIG. 7, and includes a crank portion 61 on the lower side and a lever member 62 on the upper side, and the crank portion 61 and the lever member 62 are operated in association with each other by an interlocking member 63.

The lifting mechanism 32 includes a pair of guide poles 60, and the upper abutment piece pair 30 and the lower abutment piece pair 31 are respectively attached to the guide poles 60 via holding members 65 and 66 so as to be movable up and down. That is, the holding members 65 and 66 each include linear bearings 67, and the linear bearings 67 are engaged with the guide pole 60. The upper abutment piece pair 30 is fixed to the holding member 65, and the lower abutment piece pair 31 is fixed to the holding member 66.

The interlocking member 63 is a part of the lower holding member 66 and is a plate-shaped member.

As illustrated in FIG. 7, the crank portion 61 is provided between the geared motor 52 and the lower holding member 65.

As illustrated in FIG. 7, the lever member 62 is provided between the interlocking member 63 and the upper holding member 65.

The lever member 62 has an intermediate portion 95 swingably supported by a fixed portion (not shown) via a bearing 70. Accordingly, a force point side 80 and an action point 81 side of the lever member 62 swing about the intermediate portion 95. That is, when the force point side 80 moves up, the action point 81 moves down, and when the force point side 80 moves down, the action point 81 moves up.

The force point side 80 of the lever member 62 is connected to the interlocking member 63. Further, the action point 81 side of the lever member 62 is connected to the upper holding member 65. A connection portion between the force point side 80 of the lever member 62 and the interlocking member 63 is turnable, and has a degree of freedom in a lateral direction. A connection portion between the action point 81 side of the lever member 62 and the upper holding member 65 is also turnable, and has a degree of freedom in a lateral direction.

The crank portion 61 provided on the lower side and the lever member 62 provided on the upper side are out of phase.

As described above, the interlocking member 63 is a part of the lower holding member 66, and the interlocking member 63 and the lower holding member 66 are integrally joined to each other. Accordingly, when the lower holding member 66 moves up and down, the interlocking member 63 also moves up and down.

As described above, the crank portion 61 is provided between the geared motor 52 and the lower holding member 66, and when the crank portion 61 is rotated by the geared motor 52, a rotational motion of the geared motor 52 is converted into a linear motion by the crank portion 61, and the lower holding member 66 moves up and down along the guide poles 60.

When the lower holding member 66 moves up and down, the interlocking member 63 integrated with the holding member 66 also moves up and down in the same manner, and the force point side 80 of the lever member 62 moves up and down. As a result, the action point 81 side of the lever member 62 moves down, and the upper holding member 65 moves down.

Here, when the force point side 80 of the lever member 62 moves up, the action point 81 side moves down. When the force point side 80 of the lever member 62 moves down, the action point 81 side moves up.

As described above, with the crank portion 61 and the lever member 62 being out of phase, when the lower holding member 66 moves up, the upper holding member 65 moves down. Further, when the lower holding member 66 moves down, the upper holding member 65 moves up. That is, as illustrated in FIG. 7(b), when the crank portion 61 turns and the lower holding member 66 moves up, the interlocking member 63 moves up, and the force point side 80 of the lever member 62 moves up. Then, with the force point side 80 of the lever member 62 moving up, the action point 81 side of the lever member 62 moves down, and the upper holding member 65 moves down.

Conversely, as illustrated in FIG. 7(a), when the crank portion 61 turns and the lower holding member 66 moves down, the interlocking member 63 moves down, and the force point side 80 of the lever member 62 moves down. Then, with the force point side 80 of the lever member 62 moving down, the action point 81 side of the lever member 62 moves up, and the upper holding member 65 moves up.

As described above, when the crank portion 61 rotates to a certain angle, as illustrated in FIG. 7(b), the lower holding member 66 moves up and the upper holding member 65 moves down, and the upper abutment piece pair 30 and the lower abutment piece pair 31 approach each other, are brought into contact with each other to be further pressed against each other.

When the crank portion 61 further rotates, as illustrated in FIG. 7(a), the lower holding member 66 moves down and the upper holding member 65 moves up, and the upper abutment piece pair 30 and the lower abutment piece pair 31 are separated from each other.

As described above, when the geared motor 52 rotates, the upper holding member 65 and the lower holding member 66 approach and are separated from each other, and the upper abutment piece pair 30 and the lower abutment piece pair 31 approach and are separated from each other.

The lifting mechanism 32 of this embodiment uses the crank portion 61 and the lever member 62, which are out of phase, and moves up and down the upper abutment piece pair 30 and the lower abutment piece pair 31 in directions opposite to each other by turning one geared motor 52.

The present invention is not limited to this configuration, and the upper abutment piece pair 30 and the lower abutment piece pair 31 may be moved up and down by separate motors. Further, a mechanism other than a crank and a lever may be adopted.

### Discharging Device 5

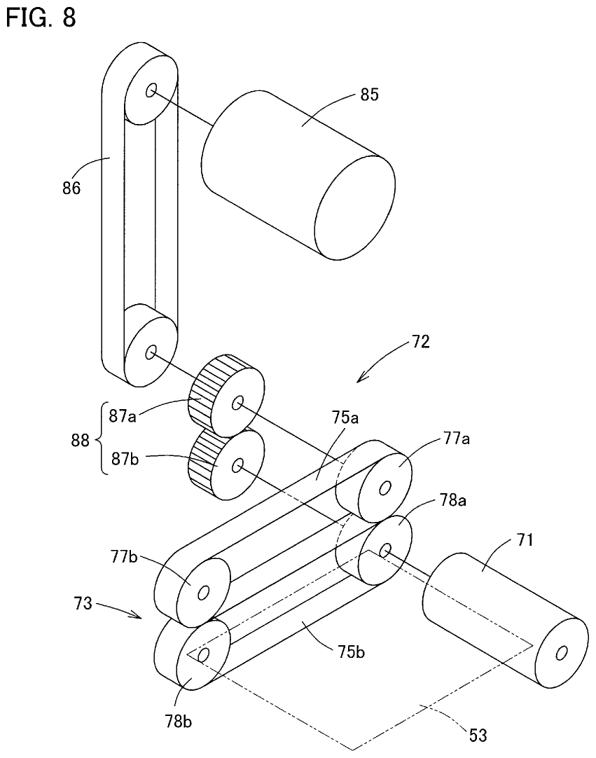

Next, the discharging device 5 is described. As illustrated in FIG. 3 and FIG. 8, the discharging device 5 includes a conveyance path member 53 and a feeding mechanism 72.

The conveyance path member 53 is a metal plate, and serves as a table on which the drug packaging strip 120 is to be placed and slid.

The feeding mechanism 72 includes a discharge roller 71 and a conveyance mechanism unit 73 using belts.

The discharge roller 71 has an upper surface that is allowed to be brought into contact with the drug packaging strip 120 to move the drug packaging strip 120.

A basic configuration of the conveyance mechanism unit 73 of the discharging device 5 is the same as that of the conveyance mechanism unit 12 of the above-mentioned feeding device 2. The conveyance mechanism unit 73 includes a pair of an upper conveyance belt 75a and a lower conveyance belt 75b, and moves the drug packaging strip 120 by sandwiching one side of the drug packaging strip 120 between the conveyance belts 75a and 75b.

The conveyance belts 75a and 75b are respectively stretched between a pair of pulleys 77a and 77b and a pair of pulleys 78a and 78b. Tension pulleys 76a and 76b are provided outside stretch paths of the conveyance belts 75a and 75b (not illustrated in FIG. 8).

The conveyance mechanism unit 73 is a mechanism for moving the drug packaging strip 120 by sandwiching one side of the drug packaging strip 120 between the conveyance belt 75a stretched between the pair of pulleys 77a and 77b, and the conveyance belt 75b stretched between the pair of pulleys 78a and 78b.

The feeding mechanism 72 includes a geared motor 85 at an upper portion, and a rotational force of the geared motor 85 is transmitted by a belt 86 to a gear train 88 including gears 87a and 87b. Then, the rotational force of the upper gear 87a of the gear train 88 is transmitted to the pulley 77a so that the upper conveyance belt 75a travels.

Further, the rotational force of the lower gear 87b of the gear train 88 is transmitted to the pulley 78a so that the lower conveyance belt 75b travels.

In addition, the rotational force of the lower gear 87b is transmitted to the discharge roller 71.

Accordingly, when the geared motor 85 is driven, a lower surface of the upper conveyance belt 75a and an upper surface side of the lower conveyance belt 75b advance in the same direction. Further, the upper surface of the discharge roller 71 also rotates in the same direction.

As described above, the drug package separating apparatus 1 includes the feeding device 2, the separating unit 3, and the discharging device 5. The feeding device 2, the separating unit 3, and the discharging device 5 are arranged in the stated order. That is, the feeding device 2 is provided on a preceding stage side of the separating unit 3, and the discharging device 5 is provided on a subsequent stage side of the separating unit 3.

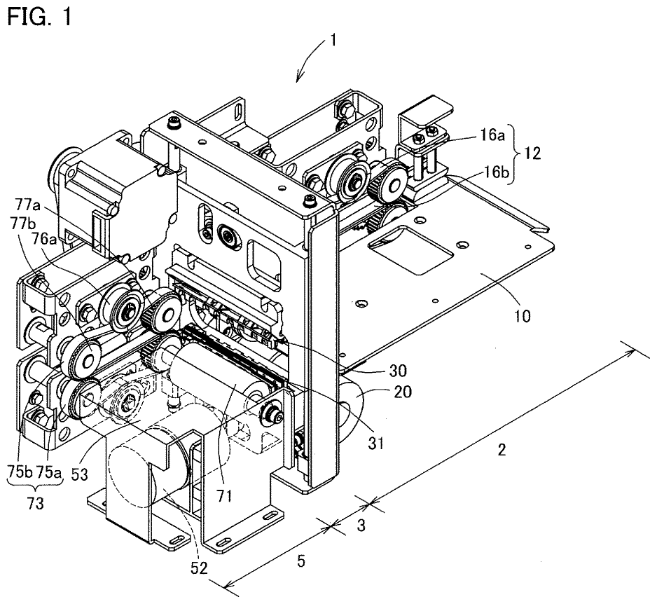

The conveyance belts 16a and 16b of the feeding device 2 and the conveyance belts 75a and 75b of the discharging device 5 are both located on a back side in FIG. 1 and FIG. 2. Further, in the separating unit 3, the first area of the upper abutment piece pair 30 and the lower abutment piece pair 31 is located on the back side in FIG. 1 and FIG. 2.

Thus, the conveyance belts 16a and 16b of the feeding device 2, a part of the first area of the upper abutment piece pair 30 and the lower abutment piece pair 31, and the conveyance belts 75a and 75b of the discharging device 5 are aligned on a straight line. As described above, the protruding piece 40 is provided in the first area.

As described above, the distance between the right abutment piece 35 and the left abutment piece 36 is narrow in the second area, and the distance becomes wider as proceeding to the areas subsequent to the second area.

Accordingly, in the vicinity of a region on an extension of the conveyance belts 16a and 16b of the feeding device 2, the distance between the right abutment piece 35 and the left abutment piece 36 is narrow, and the distance between the right abutment piece 35 and the left abutment piece 36 becomes wider as a distance from the extension line of the conveyance belts 16a and 16b increases.

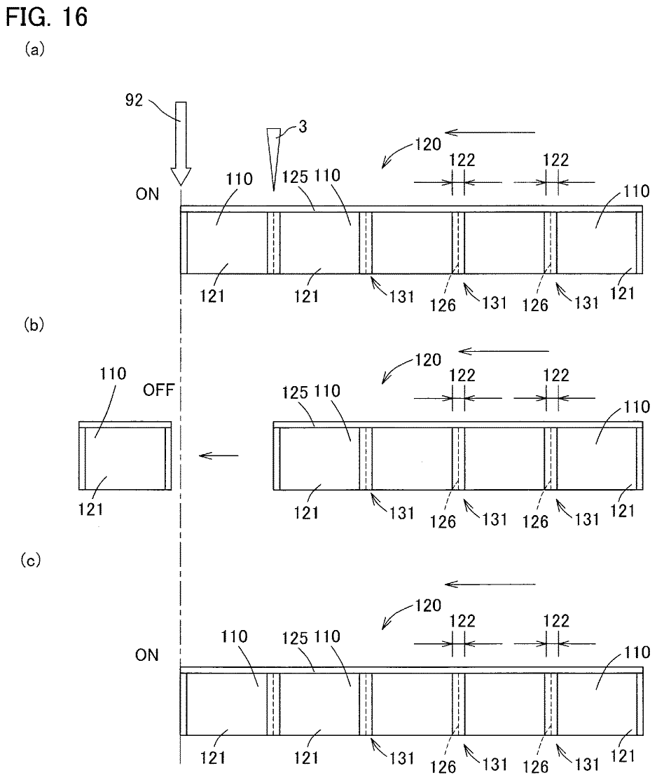

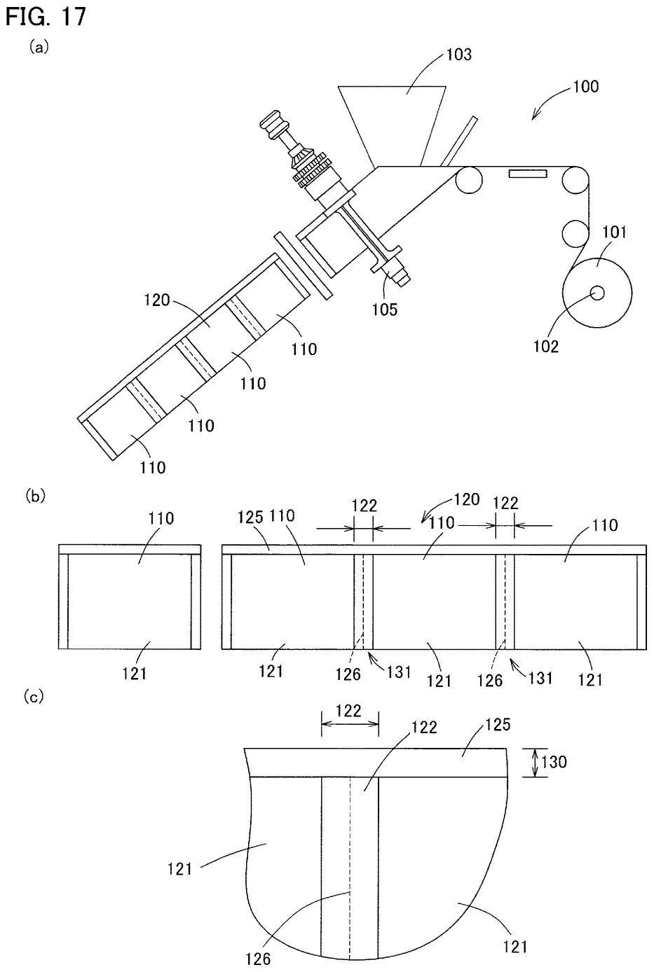

The discharging device 5 is provided with an edge sensor 92 (FIG. 16). The edge sensor 92 detects a leading edge of the drug packaging strip 120. For example, a photoelectric sensor is used as the edge sensor 92.

### Function of Drug Package Separating Apparatus 1

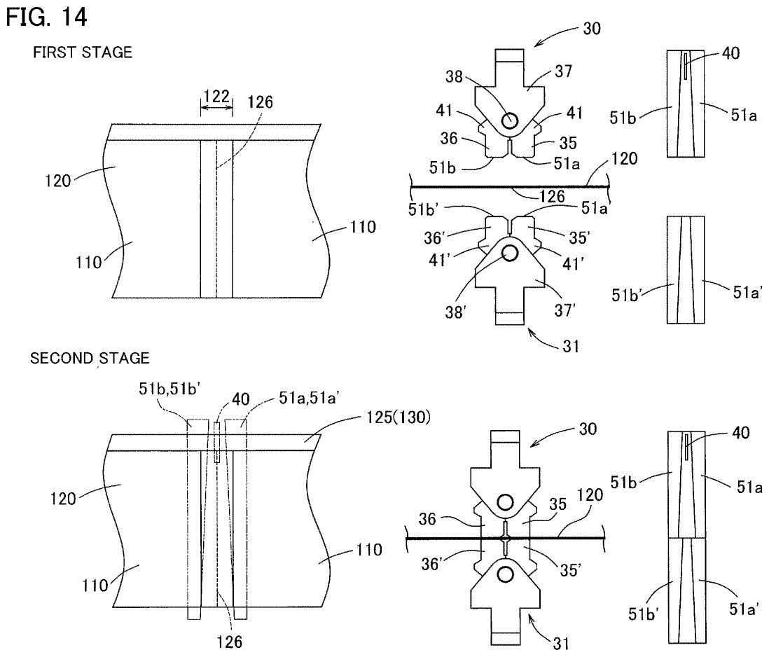

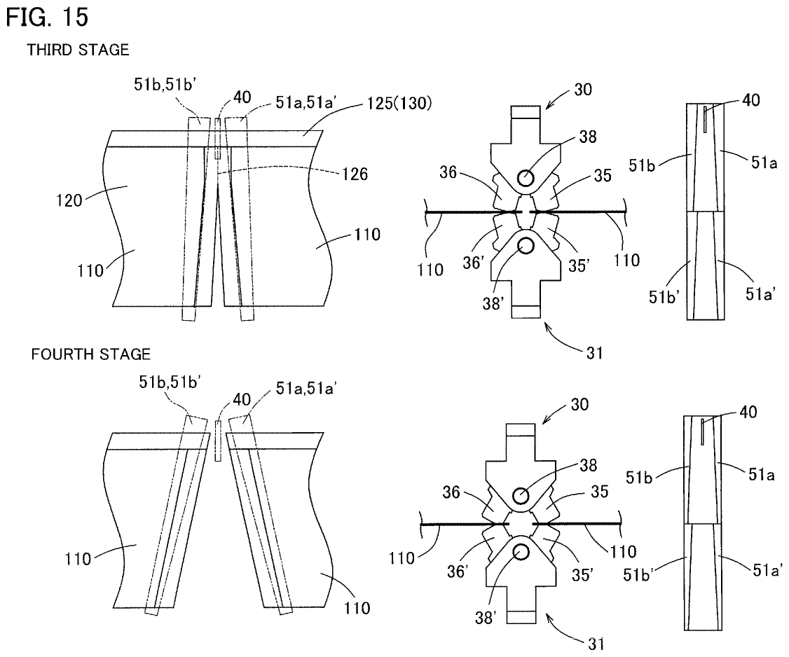

Next, a function of the drug package separating apparatus 1 is described with reference to FIG. 14, FIG. 15, and FIG. 16.

When the drug packaging strip 120 is mounted on the drug package separating apparatus 1 of this embodiment, the drug packages 110 of the drug packaging strip 120 are automatically and individually separated. Description thereof is given below in order.

The steps described below are automatically performed by a control device (not shown).

### First Stage

The drug packaging strip 120 is introduced from the feeding device 2 to be fed to the separating unit 3. At this time, the upper abutment piece pair 30 and the lower abutment piece pair 31 are spaced apart from each other.

The drug packaging strip 120 is fed one package by one package with the common seal portion 125 sandwiched between the pair of the upper conveyance belt 16a and the lower conveyance belt 16b, to enter the separating unit 3, and stops when a joining region 122 of the drug packaging strip 120 reaches a cut portion between the upper abutment piece pair 30 and the lower abutment piece pair 31.

In this embodiment, as illustrated in FIG. 16, the edge sensor 92 is installed at a position separated from the cut portion by one drug package 110. Then, the drug packaging strip 120 is moved from left to right in FIG. 16, and when the edge sensor 92 detects a leading edge of the drug packaging strip 120 as illustrated in FIG. 16(a), the feeding of the drug packaging strip 120 is stopped.

As a result, the joining region 122 of the drug packaging strip 120 stops between the upper abutment piece pair 30 and the lower abutment piece pair 31.

Instead of the measure of this embodiment, it is also recommended to adopt a configuration in which rotation pulses of the geared motor 20 of the feeding device 2 are counted, and the geared motor 20 is stopped when the number of pulses reaches a number at which the joining region 122 of the drug packaging strip 120 reaches between the upper abutment piece pair 30 and the lower abutment piece pair 31.

As in the first stage of FIG. 14, the upper abutment piece pair 30 and the lower abutment piece pair 31 each include the right abutment piece 35 and the left abutment piece 36, and a boundary line between the right abutment pieces 35 and 35′ and the left abutment pieces 36 and 36′ and the perforation 126 of the drug packaging strip 120 are present at a position matching each other in a plan view.

### Second Stage

Under this state, the geared motor 52 of the separating unit 3 is driven so that the upper abutment piece pair 30 and the lower abutment piece pair 31 are moved up and down to bring the upper abutment piece pair 30 and the lower abutment piece pair 31 into contact with the drug packaging strip 120.

That is, as in the second stage of FIG. 14, the upper abutment piece pair 30 is moved down to bring the upper abutment piece pair 30 into contact with a front surface of the drug packaging strip 120, and the lower abutment piece pair 31 is moved up to bring the lower abutment piece pair 31 into contact with a back surface of the drug packaging strip 120.

At this time, the right abutment piece 35 of the upper abutment piece pair 30 is brought into abutment against a right side (feeding device 2 side) of the perforation 126 of the drug packaging strip 120, and the left abutment piece 36 of the upper abutment piece pair 30 is brought into abutment against a left side (discharging device 5 side) of the perforation 126 of the drug packaging strip 120.

Similarly, the right abutment piece 35′ of the lower abutment piece pair 31 is brought into abutment against the right side (feeding device 2 side) of the perforation 126 of the drug packaging strip 120, and the left abutment piece 36′ of the upper abutment piece pair 30 is brought into abutment against the left side (discharging device 5 side) of the perforation 126 of the drug packaging strip 120.

Accordingly, the right side (feeding device 2 side) of the perforation 126 of the drug packaging strip 120 is held by the upper abutment piece 35 and the lower right abutment piece 35′. Further, the left side (discharging device 5 side) of the perforation 126 of the drug packaging strip 120 is held by the upper abutment piece 36 and the lower left abutment piece 36′.

Further, a tip of the protruding piece 40 of the upper abutment piece pair 30 urges the drug packaging strip 120 to make a cut.

The tip of the protruding piece 40 scratches a terminal end portion of the perforation 126 of the drug packaging strip 120. That is, the tip of the protruding piece 40 urges the perforation 126 in the vicinity of the common seal portion 125 in the accommodating portion 121 to scratch the perforation 126 to thereby make a cut. This portion has the perforation 126, and the tip of the protruding piece 40 is pointed. As a result, the perforation 126 can be easily torn by the protruding piece 40.

### Third Stage

The geared motor 52 of the separating unit 3 further rotates so that the upper abutment piece pair 30 and the lower abutment piece pair 31 are pressed against each other.

Here, the right abutment piece 35 and the left abutment piece 36 of the upper abutment piece pair 30 are swingable with respect to the common shaft 38, and the abutment portions 51a and 51b are located at positions offset with respect to the perpendicular line Y passing through the center of the common shaft 38. Further, the entire abutment portions 51a and 51b are inclined inward.

The right abutment piece 35′ and the left abutment piece 36′ of the lower abutment piece pair 31 are also swingable with respect to the common shaft 38′, and the abutment portions 51′a and 51′b are located at positions offset with respect to the perpendicular line Y passing through the center of the common shaft 38. Further, the entire abutment portions 51′a and 51′b are inclined inward.

Accordingly, with the upper abutment piece pair 30 and the lower abutment piece pair 31 being pressed against each other, as in the third stage of FIG. 15, the right abutment pieces 35 and 35′ and the left abutment pieces 36 and 36′ turn to change postures thereof so that the distance between the abutment portions 51a and 51b and the distance between the abutment portions 51′a and 51′b are increased under a state in which the abutment portions 51a and 51b and the abutment portions 51′a and 51′b hold both ends of the perforation 126. As a result, both sides of the perforation 126 are pulled right and left under the state of being held, so that the perforation 126 is torn.

The protruding piece 40 is further pushed deeply into the packaging paper sheet. The protruding piece 40 has the inclined line 91 connected to the straight line 90, and hence, when the protruding piece 40 is pushed further deeply, the perforation 126 is brought into a state of being easily torn right and left starting from the length of the inclined line 91 (a cut is easily made). As a result, a cut following the perforation 126 extends to the common seal portion 125 side, so that a cut is made so as to reach a seal portion 130.

### Fourth Stage

Further, in this embodiment, the main body portion 43 of each of the right abutment piece 35 and the left abutment piece 36 is divided into four areas in the longitudinal direction. The distance between the right abutment piece 35 and the left abutment piece 36 in the second area is the narrowest, and the distance therebetween in the fourth area is the widest. In relation to the drug packaging strip 120, the distance on the common seal portion 125 side is narrow, and the distance on a bottom side of the bag (folded side of the packaging paper sheet) is wide.

Accordingly, the bottom side of the bag (folded side of the packaging paper sheet) is more strongly pulled right and left so that the perforation 126 is torn from the bottom side of the bag. Further, the protruding piece 40 is provided on the common seal portion 125 side of the upper abutment piece pair 30, and hence the protruding piece 40 pierces the vicinity of the upper abutment piece pair 30 to make a cut in the common Seal portion 125. Following the separation performed sequentially along the perforation from the bottom side (folded side of the packaging paper sheet), the common seal portion 125 is separated toward both sides of the protruding piece 40.

Accordingly, when the upper abutment piece pair 30 and the lower abutment piece pair 31 further approach each other, the entire perforation 126 is cut, and in addition, the common seal portion 125 is also separated.

The separated drug package 110 is discharged to the outside by the discharging device 5.

At the same time, the geared motor 52 of the separating unit 3 is driven, the upper abutment piece pair 30 and the lower abutment piece pair 31 are separated from each other, and a new drug package 110 is further conveyed from the feeding device 2 to the separating unit 3 to be separated.

That is, as illustrated in FIG. 16, the edge sensor 92 is installed on an outlet side of the separating unit 3 at a position separated from the separating unit 3 by one drug package 110, and the edge sensor 92 monitors the presence or absence of the drug packaging strip 120. In this embodiment, as illustrated in FIG. 16, a tearing operation is executed while the edge sensor 92 detects the drug packaging strip 120 (with the edge sensor 92 turned on), and when the drug packaging strip 120 is torn by the upper abutment piece pair 30 and the lower abutment piece pair 31, the cut drug package 110 is discharged to the outside by the discharging device 5. That is, the conveyance belts 75a and 75b and the roller 71 of the discharging device 5 rotate so that the separated drug package 110 is discharged.

When the drug package 110 is discharged, the edge sensor 92 turns off as illustrated in FIG. 16(b).

When the edge sensor 92 remains on, notification is given of an error, assuming that the separation of the drug package 110 has not been successfully performed.

The steps from the first stage to the fourth stage described above are sequentially repeated, and the drug packaging strip 120 is separated into the drug packages 110.

That is, when the first drug package 110 is normally separated to be discharged to the outside, the edge sensor 92 turns off. At this point, the feeding of the drug packaging strip 120 remaining upstream is resumed, and when a leading edge of the next drug package 110 reaches the position of the edge sensor 92 and the edge sensor 92 turns on, the feeding of the drug packaging strip 120 is stopped (first stage).

At this time, the separating unit 3 is located around the perforation 126 between a next package and a package after the next package, and hence, similarly to the foregoing, the drug packaging strip 120 is torn by the upper abutment piece pair 30 and the lower abutment piece pair 31 (second stage to fourth stage).

The drug package separating apparatus 1 of this embodiment has a mechanism for mainly separating adjacent drug packages 110 of the drug packaging strip 120 from each other, and tearing a portion between the adjacent drug packages 110. That is, the mechanism of the drug package separating apparatus 1 of this embodiment is a mechanism for separating the adjacent drug packages 110 from each other, not for cutting by inserting a blade while aiming at the perforation 126 of the drug packaging strip 120.

Accordingly, in the drug package separating apparatus 1 of this embodiment, it is sufficient to position the drug packaging strip 120 so that the abutment portions 51a and 51b are located on both sides of the perforation 126, and hence an effect that high positioning accuracy is not required is obtained.

There are various lengths of the drug package 110, such as 80 mm, 70 mm, and 60 mm, depending on a drug amount contained in a prescription. However, in the drug package separating apparatus 1 of this embodiment, a distance between the edge sensor 92 and the separating unit 3 is, in principle, set to the same distance as the length of the drug package 110, because, after the preceding drug package 110 is separated, when the leading edge of the next drug package 110 reaches the position of the edge sensor 92 and the edge sensor 92 turns on, the feeding of the drug packaging strip 120 is stopped. In the drug package separating apparatus 1 of this embodiment, with the position of the edge sensor 92 being set as described above, when the drug package 110 is detected by the edge sensor 92 and the feeding is stopped, the drug packaging strip 120 has been fed by one package, and the abutment portions 51a and 51b are located on both sides of the next perforation 126.

In this embodiment, the position of the edge sensor 92 is fixed, but a plurality of edge sensors 92 may be provided according to the length of the drug package 110, or the edge sensor 92 may be movable so as to be moved to a position corresponding to the length of the drug package 110.

The drug package separating apparatus 1 of the embodiment described above includes the abutment piece pair 30 on the upper side and the abutment piece pair 31 on the lower side, and the upper abutment piece pair 30 and the lower abutment piece pair 31 move to sandwich the drug packaging strip 120. However, the present invention is not limited to this configuration, and only one of the abutment piece pairs may move to sandwich the drug packaging strip 120.

Further, the drug package 110 can also be separated by pressing only one abutment piece pair against the drug packaging strip 120, instead of sandwiching the drug packaging strip 120 with the two abutment piece pairs 30 and 31.

In the drug packaging strip 120 described in the embodiment described above, the perforation 126 does not reach the common seal portion 125, and hence the common seal portion 125 is the seal portion 130 having no separation line. However, the drug package separating apparatus of the present invention can be used not only for the drug packaging strip 120 in which the perforation 126 ends midway as described above, but also for a drug packaging strip 120 in which a perforation 126 is formed over the entire width of the drug packaging strip 120.

In the drug package separating apparatus 1 of the embodiment described above, a cut is made in the drug packaging strip 120 by the protruding piece 40 on the upper abutment piece pair 30. This configuration is recommended, but a sufficient effect can be expected even by only urging the drug packaging strip 120 by the protruding piece 40.

Further, in the present invention, the protruding piece 40 is not essential, and the protruding piece 40 may be omitted. In the above-mentioned embodiment, due to the presence of the protruding piece 40, the distance between the right abutment piece 35 and the left abutment piece 36 in the second area is the narrowest, but when the protruding piece 40 is not provided, it is desired that the distance between the right abutment piece 35 and the left abutment piece 36 in the first area be the narrowest.

In the drug package separating apparatus 1 of the embodiment described above, the drug packaging strip 120 is conveyed in the horizontal direction, and the drug packaging strip 120 is torn into an upstream side and a downstream side by being sandwiched between the upper abutment piece pair 30 and the lower abutment piece pair 31. However, the conveyance direction of the drug packaging strip 120 may be a diagonal direction or the up-down direction. For example, the drug packaging strip 120 may be moved in the up-down direction to suspend the drug packaging strip 120, and the front side and the back side of the drug packaging strip 120 may be sandwiched between the one-side abutment piece pair 30 and the another-side abutment piece pair 31 to tear the drug packaging strip 120.

The drug package separating apparatus 1 described above is a drug package separating apparatus that individually separates the drug packages from a drug packaging strip in which the drug packages are connected in a band shape, and the apparatus includes: a pair of abutment portions that are brought into contact with the same surface of the drug packaging strip; and a protruding piece. When a distance between the abutment portions is increased while the abutment portions are in contact with the drug packaging strip, the abutment portions urge the drug packaging strip in a direction of separating the drug packages from each other, and the protruding piece forms a cut in a part of the drug packaging strip.

The drug package separating apparatus of this aspect includes a pair of abutment portions that are brought into contact with the same surface of the drug packaging strip. It is desired that the pair of abutment portions be set so as to be brought into contact with the same surface of the drug packaging strip across the perforation of the drug packaging strip, although not limited thereto. In the drug package separating apparatus of this aspect, the distance between the abutment portions is increased while the abutment portions are in contact with the drug packaging strip. Accordingly, the drug packaging strip is urged in a direction of separating the drug packages from each other. As a result, the drug packaging strip is pulled right and left across the perforation to be torn along the perforation.

Further, the drug package separating apparatus of this aspect includes the protruding piece, and a cut is formed in a part of the drug packaging strip by the protruding piece. Accordingly, even when there is a seal portion without a perforation, cutting of the drug packaging strip begins and proceeds from the cut formed by the protruding piece so that the drug package is separated from the drug packaging strip.

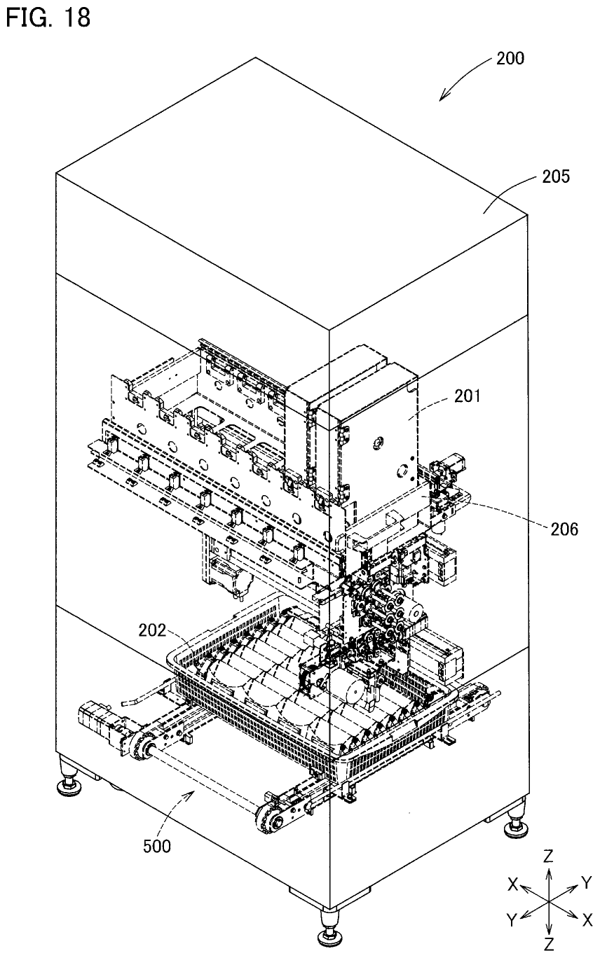

Next, a second embodiment of the present invention is described with reference to FIG. 18 and the subsequent figures. A drug package separating apparatus 200 of the second embodiment operates three-dimensionally, and hence expressions of an X-axis, a Y-axis, and a Z-axis may be included in the description. In this embodiment, when the drug package separating apparatus 200 is viewed from the front, a right-left direction corresponds to the X-axis, a depth direction corresponds to the Y-axis, and a height direction corresponds to the Z-axis.

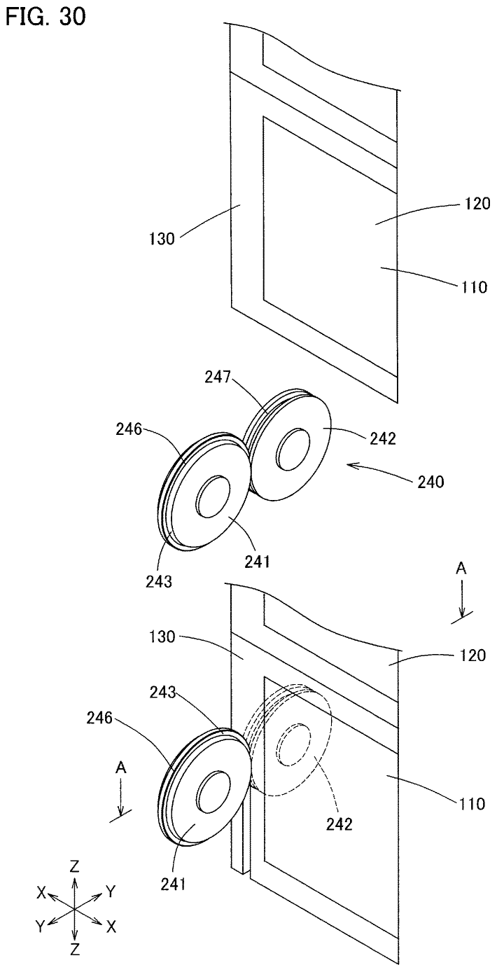

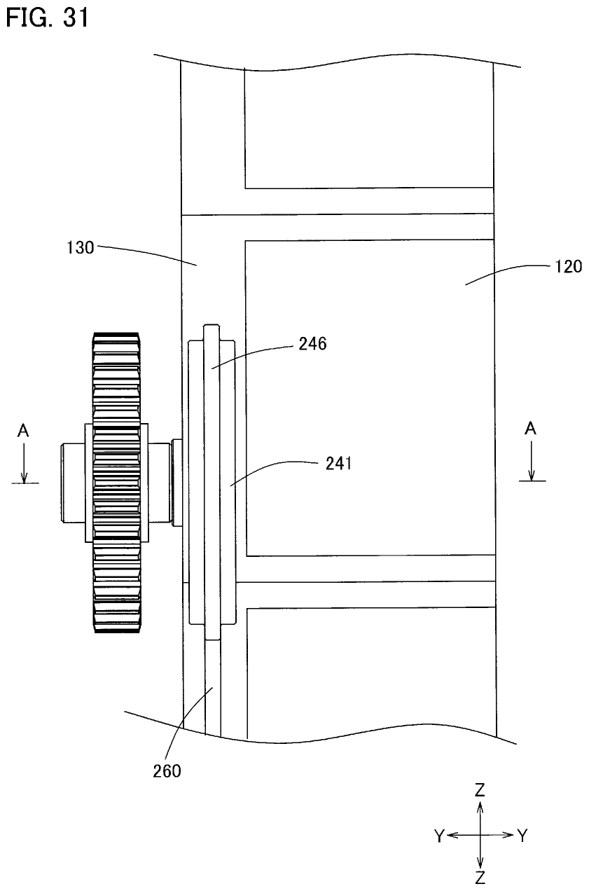

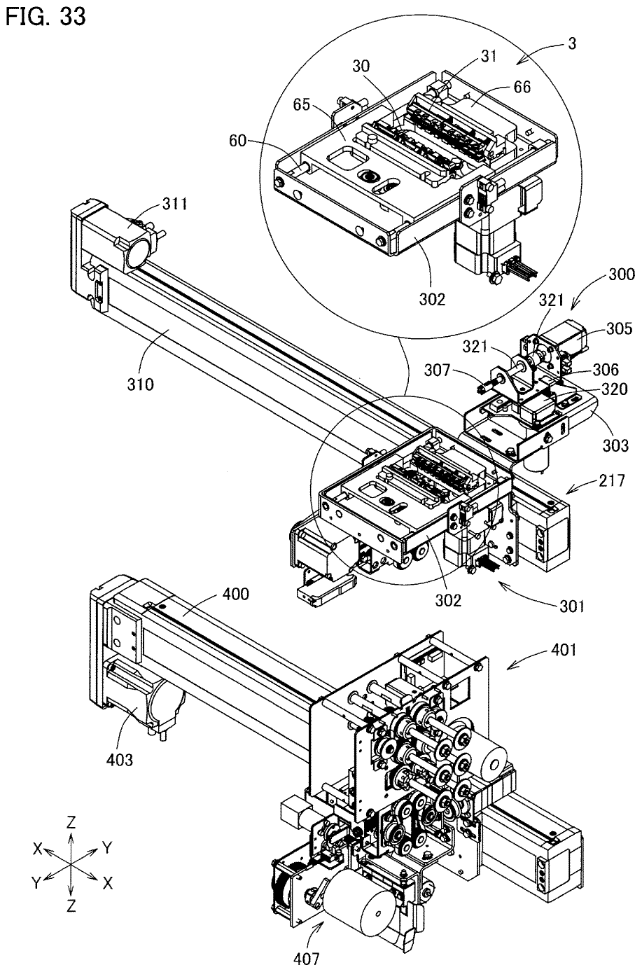

The drug package separating apparatus 200 of the second embodiment incorporates the separating unit 3 of the first embodiment. The drug package separating apparatus 200 of this embodiment adopts a configuration in which, as illustrated in FIG. 33, the separating unit 3 is installed in the horizontal direction (XY plane), and as illustrated in FIG. 30 and FIG. 31, the drug packaging strip 120 is moved in the up-down direction (Z-axis direction) to suspend the drug packaging strip 120, and the front side and the back side of the drug packaging strip 120 are sandwiched between the one-side abutment piece pair 30 and the another-side abutment piece pair 31 to tear the drug packaging strip 120.

Further, the drug package separating apparatus 200 can be provided with a plurality of roll cassettes 201, each of which is allowed to accommodate the drug packaging strip 120, and the drug packaging strip 120 is supplied from a selected roll cassette 201 to the separating unit 3 to separate the drug package 110 from the drug packaging strip 120.

Further, in the drug package separating apparatus 200 of the second embodiment, a distribution box 202 is installed at a lower portion (downward in the Z-axis direction) so that the separated drug package 110 can be inserted into a predetermined compartment 203 of the distribution box 202.

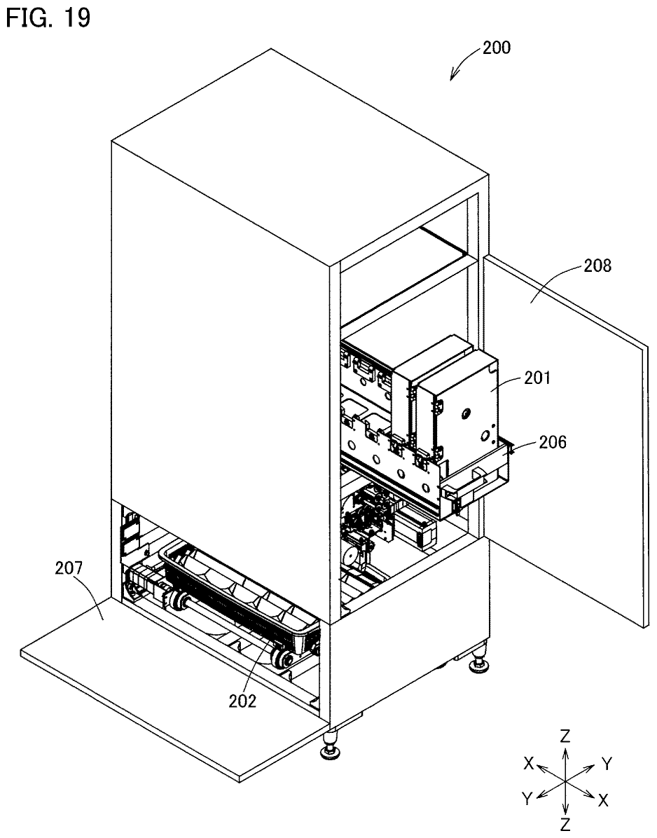

An external appearance of the drug package separating apparatus 200 of this embodiment is as illustrated in FIG. 18 and FIG. 19, and is covered with a vertical rectangular parallelepiped outer member 205. On a side surface of the outer member 205 and on an upper side of the side surface, an upper door 208 through which a cassette tray 206 is allowed to be taken in and out is provided, as illustrated in FIG. 19. Further, on a front surface of the outer member 205 and on a lower side of the front surface, a lower door 207 through which the distribution box 202 is allowed to be taken in and out is provided, as illustrated in FIG. 19.

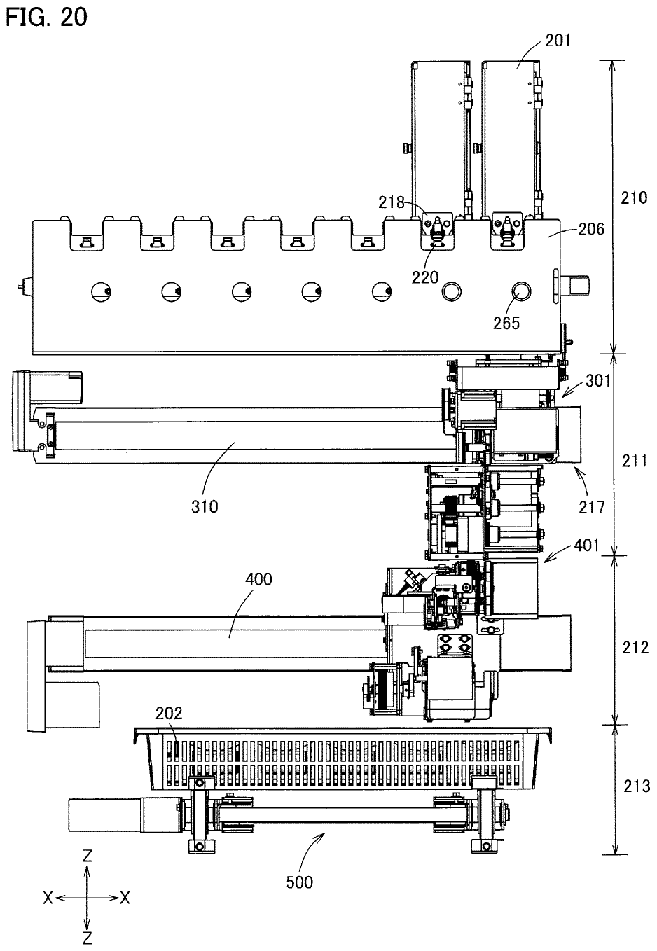

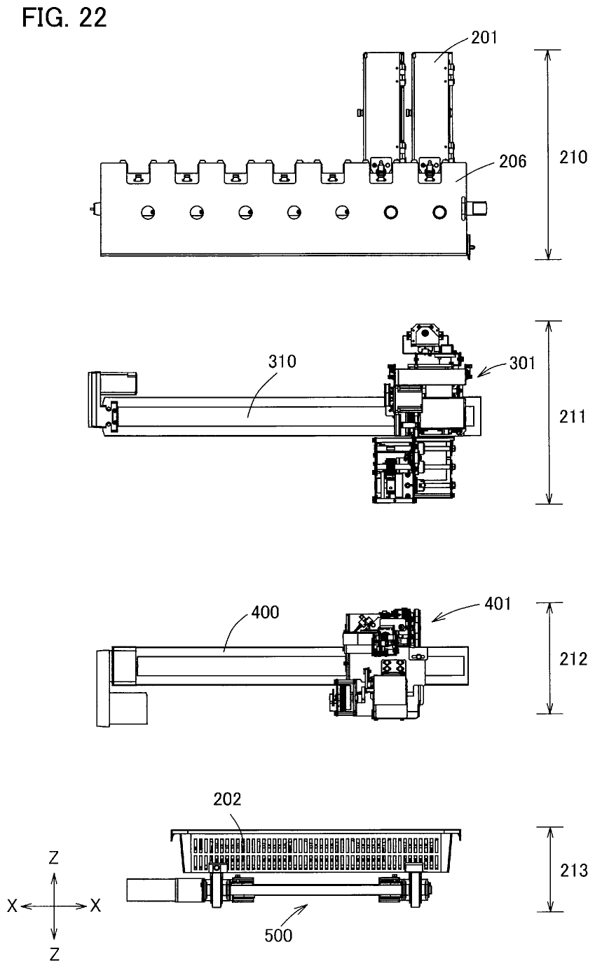

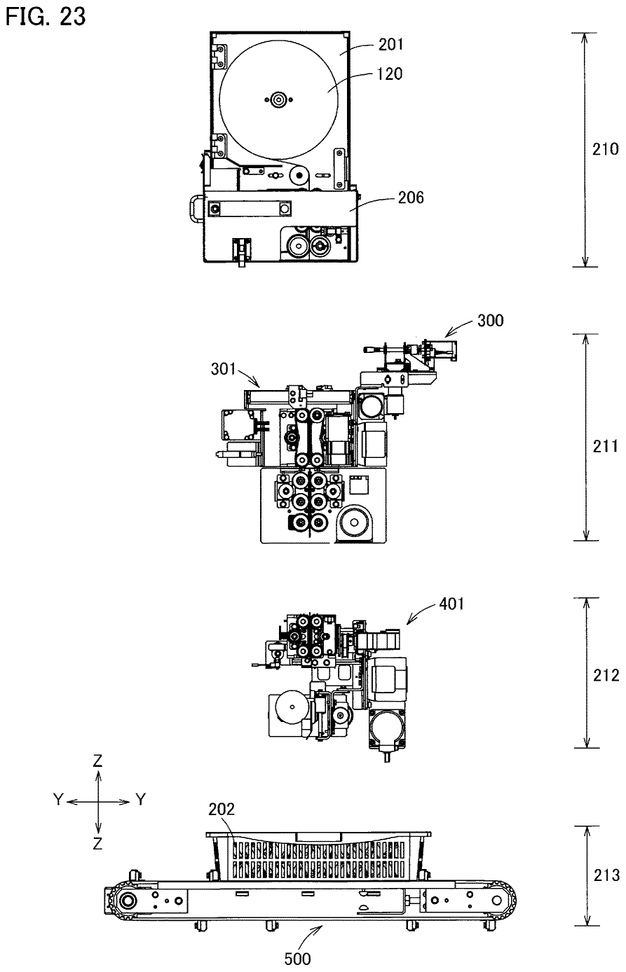

Next, an internal structure of the drug package separating apparatus 200 is described. As illustrated in FIG. 20 to FIG. 24, the drug package separating apparatus 200 has a cassette accommodating region 210, a separating region 211, a distributing region 212, and a distribution box installation region 213. Description thereof is given below individually.

### Cassette Accommodating Region 210

The cassette accommodating region 210 is a portion at which a plurality of roll cassettes 201 are to be installed via the cassette tray 206.

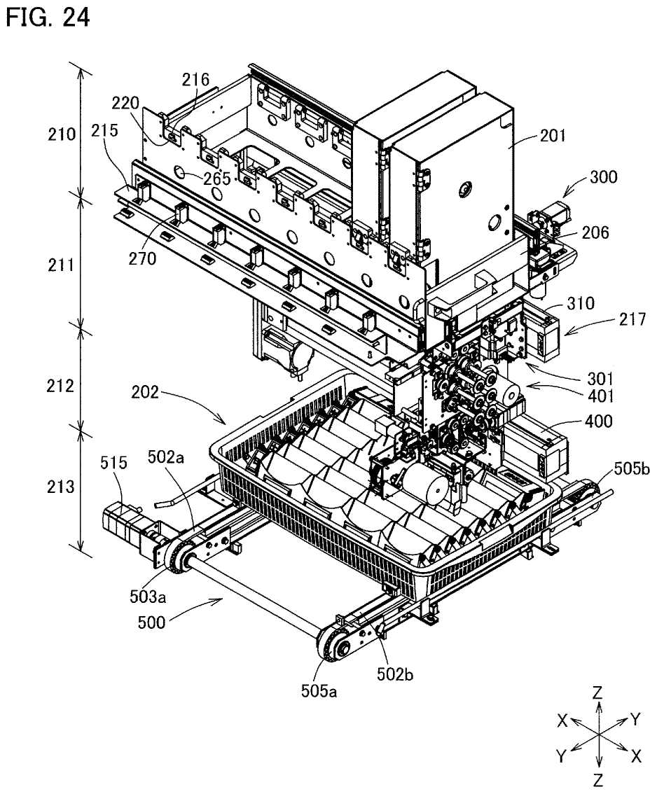

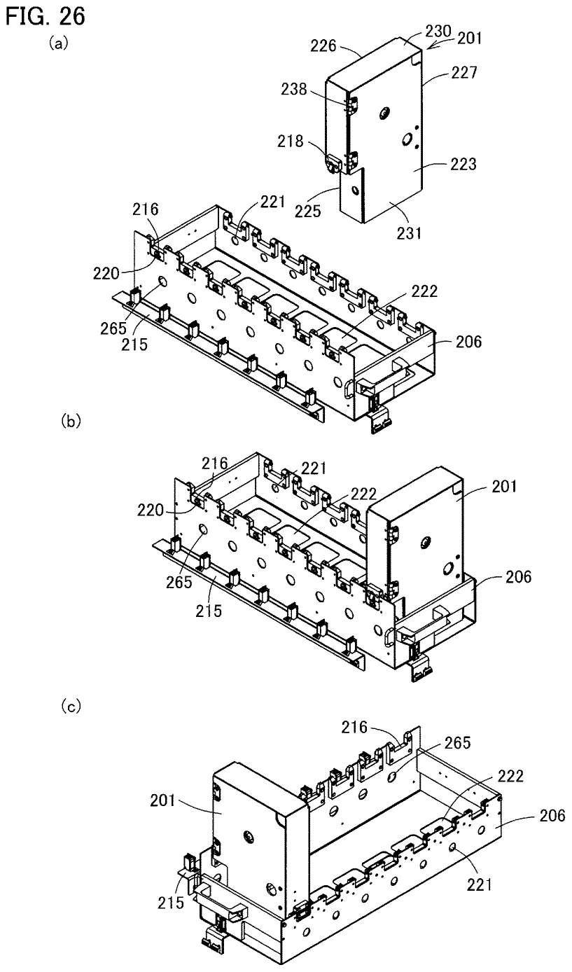

The cassette accommodating region 210 includes a drawer rail 215 as illustrated in FIG. 24, and FIG. 26(a) and FIG. 26 (b), and the cassette tray 206 is installed on the drawer rail 215. The cassette tray 206 moves linearly in the X-axis direction along the drawer rail 215 to be allowed to be accommodated in the outer member 205 as illustrated in FIG. 18, and to be pulled out from the outer member 205 as illustrated in FIG. 19.

A structure of the drawer rail 215 is the same as that of a well-known slide-type drawer rail, and thus detailed description thereof is omitted.

### Cassette Tray 206

As illustrated in FIG. 24 and FIG. 26, the cassette tray 206 is a container that is rectangular in a plan view and has an open upper side.

A plurality of cutouts 216 and a plurality of holes 265 are formed in one side surface of the cassette tray 206. Further, an engagement hook 220 is provided in the vicinity of each of the cutouts 216. Holes 221 are formed in another side surface of the cassette tray 206. Further, a plurality of through holes 222 are formed in a bottom of the cassette tray 206.

### Roll Cassette 201

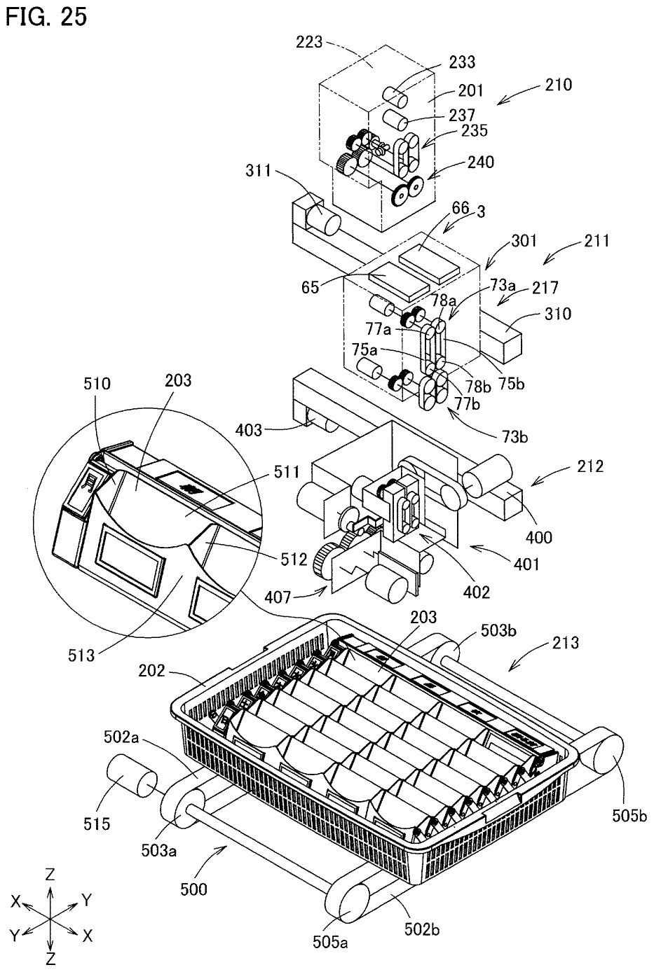

The roll cassette 201 is described with reference to FIG. 25, and FIG. 26 to FIG. 29.

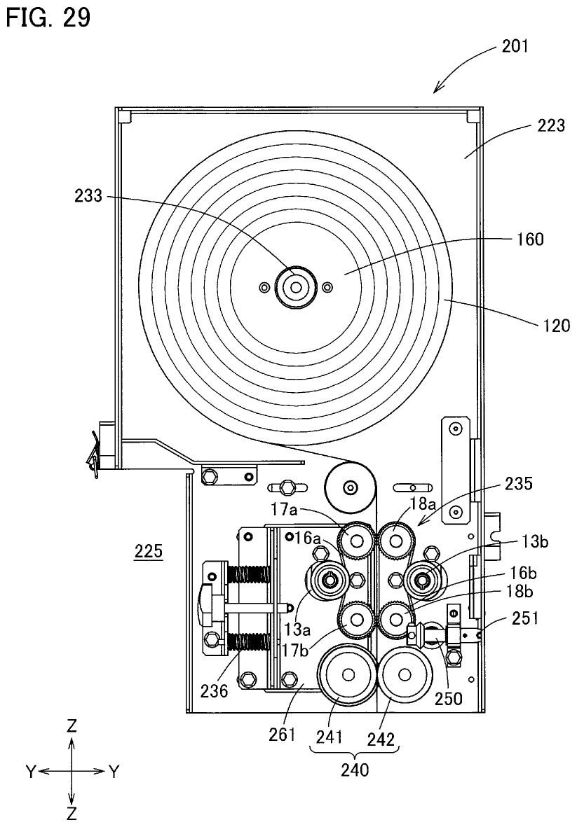

In the roll cassette 201, a reel 160, on which a continuous drug packaging strip 120 subjected to unit-dose packaging by a unit-dose packaging machine based on prescription information has been wound in a roll shape as illustrated in FIG. 29, is allowed to be accommodated.

Further, the roll cassette 201 adopted in this embodiment has a function corresponding to the “feeding device 2” in the preceding embodiment. In addition, the roll cassette 201 includes a warpage removing roller pair 240 as described later, and has a function of removing warpage of the drug packaging strip 120 by sandwiching the seal portion 130 of the drug packaging strip 120 by the warpage removing roller pair 240 to make a crease.

The roll cassette 201 includes a case member 223 that has a small thickness and is substantially rectangular in a front view. The case member 223 has a cutout portion 225 formed at a lower corner of the case member 223 based on an attachment posture.

The case member 223 includes a main body portion 230 including a back wall 226 and a peripheral wall 227 based on the attachment posture, and a front wall 231 is provided on a front side. The front wall 231 is transparent, and is attached to the main body portion 230 via hinges 238. Accordingly, the front wall 231 of the case member 223 can be opened and closed.

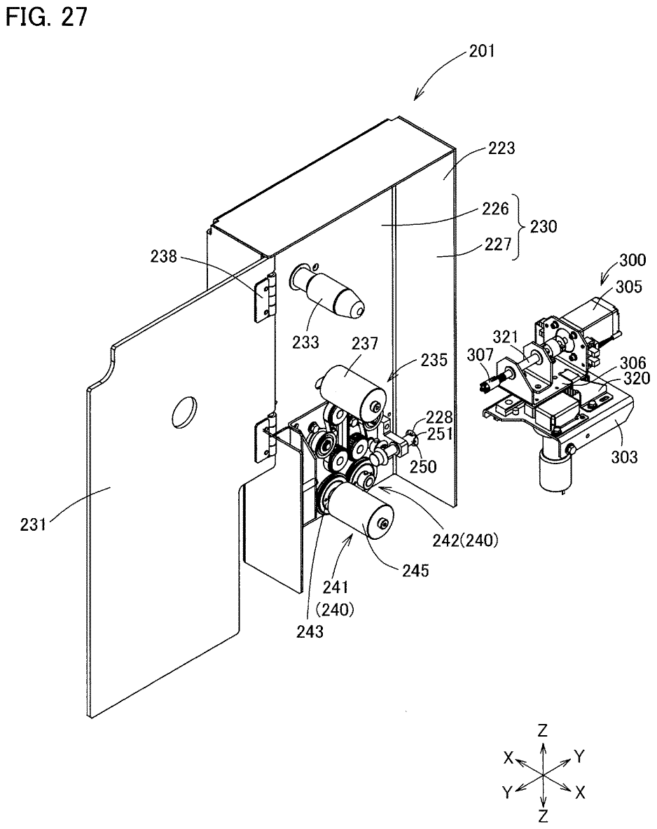

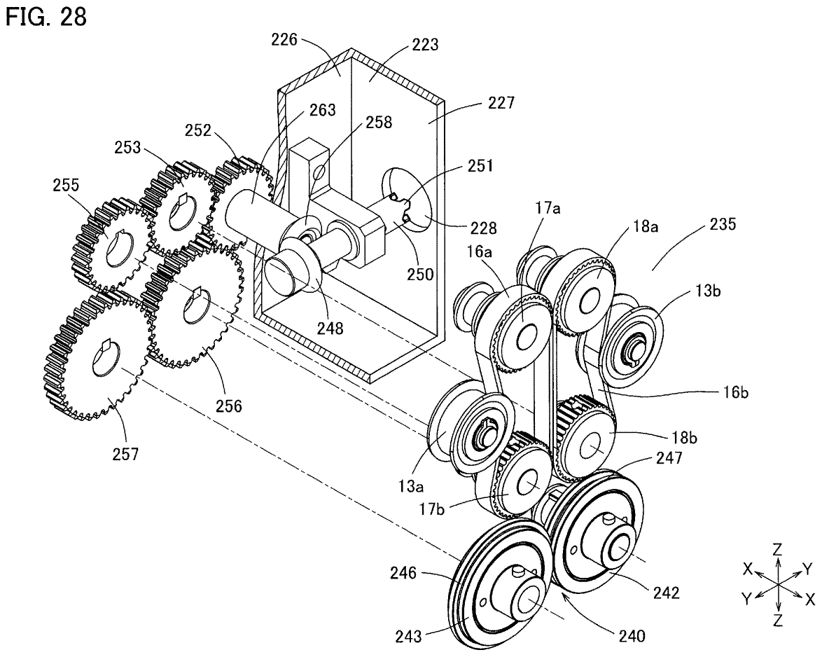

As illustrated in FIG. 27 and FIG. 28, a through hole 228 is formed in a side surface of the case member 223. Further, as illustrated in FIG. 26, a toggle-type engagement member 218 is provided at a position above the cutout portion 225 of the Case member 223.

Inside the case member 223, as illustrated in FIG. 25, FIG. 27, and FIG. 29, a reel attachment shaft 233, a guide roller 237, a feeding device 235, and the warpage removing roller pair 240 are provided.

That is, the reel attachment shaft 233 is provided on an upper portion side of the case member 223 based on the attachment posture. The reel attachment shaft 233 protrudes from the back wall 226 of the case member 223 in a cantilevered manner. The reel attachment shaft 233 is supported by a bearing (not shown), and is freely rotatable.

The guide roller 237 is provided at a position directly below the reel attachment shaft 233. The guide roller 237 is supported by a bearing (not shown), and is freely rotatable.

The feeding device 235 is provided at a lower portion of the case member 223. The feeding device 235 is similar to the feeding device 2 of the first embodiment, and as illustrated in FIG. 29, moves the drug packaging strip 120 by sandwiching one side of the drug packaging strip 120 between the conveyance belt 16a stretched between the pair of pulleys 17a and 17b, and the conveyance belt 16b stretched between the pair of pulleys 18a and 18b. The tension pulleys 13a and 13b are provided outside stretch paths of the conveyance belts 16a and 16b (not illustrated in FIG. 25).

The warpage removing roller pair 240 is provided below the feeding device 235. As illustrated in FIG. 28, FIG. 29, and FIG. 30, the warpage removing roller pair 240 includes an annularly-protruding roller 241 and a grooved roller 242.

As illustrated in FIG. 28, the annularly-protruding roller 241 is formed by integrating an engaging portion 243 and a holding portion 245 with each other, and the engaging portion 243 is formed on a base side.

The engaging portion 243 is a thin roller, and a protruding ridge 246 is formed on a peripheral portion thereof. The holding portion 245 has an appropriate length. A sectional shape of the protruding ridge 246 is a quadrangle.

The grooved roller 242 has a recessed groove 247 in a peripheral portion thereof.

The pair of pulleys 17a and 17b of the above-mentioned feeding device 235 and the annularly-protruding roller 241 of the warpage removing roller pair 240 are attached to a common movable plate 261 as illustrated in FIG. 29, and are pressed toward another side by a spring 236.

That is, the pair of pulleys 17a and 17b of the feeding device 235 are pressed toward the another pair of pulleys 18a and 18b side. Further, the annularly-protruding roller 241 of the warpage removing roller pair 240 is pressed toward the grooved roller 242 side so that the protruding ridge 246 of the engaging portion 243 enters the recessed groove 247 of the grooved roller 242.

Next, a drive mechanism of the roll cassette 201 is described with reference to FIG. 28.

In this embodiment, the feeding device 235 and the warpage removing roller pair 240 incorporated in the case member 223 are driven by receiving power transmitted from the outside.

In this embodiment, as illustrated in FIG. 28, a power transmission shaft 250 is rotatably installed in the case member 223, on an axis of the through hole 228 formed in the side surface of the case member 223. A clutch piece 251 is provided at one end of the power transmission shaft 250. A bevel gear 248 is attached to one end of the power transmission shaft 250.

As illustrated in FIG. 28, a through transmission shaft 263 that passes through the back wall 226 of the case member 223 is provided, and a bevel gear 258 is provided on the through transmission shaft 263, on an inner side of the case member 223. Further, a gear 252 is provided on the through transmission shaft 263, on an outer side of the case member 223.

Gears 253, 255, 256, and 257, in addition to the above-mentioned gear 252, are provided on a back side of the case member 223.

The gears 253 and 255 on the back side are used in driving the feeding device 235 in the case member 223. The gear 253 is connected to the pulley 18b of the feeding device 235, and the gear 255 is connected to the pulley 17b of the feeding device 235.

Further, the gears 256 and 257 on the back side are used in driving the warpage removing roller pair 240 in the case member 223. The gear 256 is connected to the grooved roller 242 of the warpage removing roller pair 240, and the gear 257 is connected to the annularly-protruding roller 241 of the warpage removing roller pair.

Then, a rotational force of the bevel gear 248 of the power transmission shaft 250 is transmitted to the gear 252 provided on the back side of the case member 223 via the bevel gear 258 provided on the through transmission shaft 263.

On the back side of the case member 223, the gear 252 is also engaged with the gear 253, and the gear 253 is engaged with the gear 255. Accordingly, when the gear 252 rotates, the gear 253 rotates so that the pulley 18b of the feeding device 235 rotates. Further, the gear 255 receives power transmitted from the gear 253, to rotate so that the pulley 17b of the feeding device 235 rotates. Accordingly, when the power transmission shaft 250 rotates, the feeding device 235 in the case member 223 is driven.

Further, on the back side of the case member 223, the gear 252 is engaged with the gear 256, and the gear 256 is engaged with the gear 257. Accordingly, when the gear 252 rotates, the gear 256 rotates so that the grooved roller 242 of the warpage removing roller pair 240 rotates. Further, the gear 257 receives power transmitted from the gear 256, to rotate so that the annularly-protruding roller 241 of the warpage removing roller pair 240 rotates. Accordingly, when the power transmission shaft 250 rotates, the warpage removing roller pair 240 in the case member 223 is driven.

Next, a function of the roll cassette 201 is described.

As illustrated in FIG. 29, the reel 160, on which the drug packaging strip 120 has been wound in a roll shape, is mounted on the roll cassette 201. That is, the front wall 231 is opened, and the reel 160 is mounted on the reel attachment shaft 233. Then, an end portion of the drug packaging strip 120 is sandwiched by the feeding device 235.

When the power transmission shaft 250 is rotated under this state, the drug packaging strip 120 is fed downward.

The drug packaging strip 120 discharged from the feeding device 235 advances to the warpage removing roller pair 240 on a downstream side, and the seal portion 130 of the drug packaging strip 120 is sandwiched between the engaging portion 243 of the annularly-protruding roller 241 and the grooved roller 242, as illustrated in FIG. 30 and FIG. 31.

As described above, the engaging portion 243 includes the protruding ridge 246 on the peripheral portion thereof, and the grooved roller 242 has the recessed groove 247 in the peripheral portion thereof. The annularly-protruding roller 241 is pressed toward the grooved roller 242 side, and the protruding ridge 246 of the engaging portion 243 enters the recessed groove 247 of the grooved roller 242.

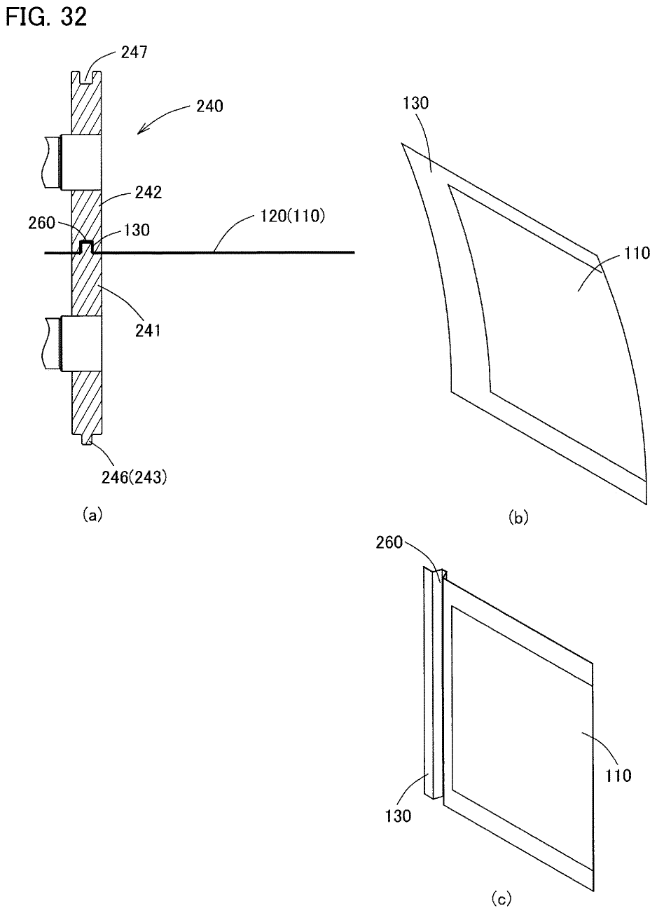

In this embodiment, as illustrated in FIG. 32(a), the seal portion 130 of the drug packaging strip 120 is bit between the protruding ridge 246 of the engaging portion 243 and the recessed groove 247 of the grooved roller 242. Accordingly, as illustrated in FIG. 31 and FIG. 32(c), a crease 260 being continuous in a longitudinal direction is formed on the seal portion 130 of the drug packaging strip 120.

The warpage removing roller pair 240 of this embodiment is used in removing warpage of the drug packaging strip 120, and with the drug packaging strip 120 being caused to pass through the warpage removing roller pair 240, warpage of the drug packaging strip 120 is removed so that the drug packaging strip 120 has a straight shape.

That is, the drug packaging strip 120 fed out from the reel 160 has warpage as illustrated in FIG. 32(b), and hence tends to be in a rolled shape. With the drug packaging strip 120 being caused to pass through the warpage removing roller pair 240, the warpage of the drug packaging strip 120 is removed so that the drug packaging strip 120 has a straight shape as illustrated in FIG. 32(c).

The drug packaging strip 120 having the crease 260 made thereon is discharged from the cassette tray 206 to be suspended.

A plurality of roll cassettes 201 are mounted on the cassette tray 206 as illustrated in FIG. 20 and the like.

As described above, the toggle-type engagement member 218 is provided on the side surface of the roll cassette 201, and the engagement hook 220 is provided on the cassette tray 206. In this embodiment, the roll cassette 201 is inserted into an accommodating portion of the cassette tray 206, and the toggle-type engagement member 218 of the roll cassette 201 is engaged with the engagement hook 220 of the cassette tray 206 to fix the roll cassette 201 to the cassette tray 206.

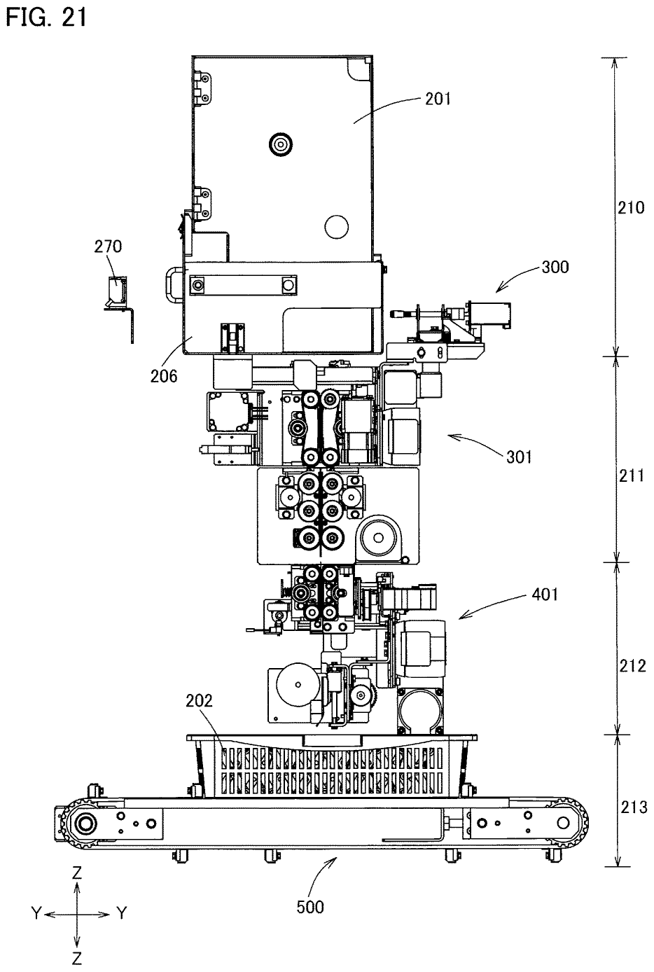

Further, as illustrated in FIG. 21 and FIG. 24, a large number of photoelectric sensors 270 are installed in the cassette accommodating region 210, and the photoelectric sensors 270 monitor an inside of the cassette tray 206 through the holes 265 of the cassette tray 206. In this embodiment, the presence or absence of the drug packaging strip 120 is confirmed by the photoelectric sensor 270. That is, information as to in which accommodating portion of the cassette tray 206 the cassette tray 206 is present is detected to be transmitted to a control device (not shown). A sensor that is used in confirming the presence or absence of the roll cassette 201 may be provided.

### Separating Region 211

Next, the separating region 211 is described with reference to FIG. 25 and FIG. 33. The separating region 211 is a region having functions corresponding to the separating unit 3 and the conveyance mechanism unit 73 of the first embodiment. Further, in this embodiment, there is provided a lateral movement function 217 of moving the separating unit 3 and the like to a position of the cassette tray 206 in the cassette accommodating region 210 on the upper side. In addition, in the separating region 211, a driving device 300 that drives the cassette tray 206 is mounted, as illustrated in FIG. 33.

In this embodiment, three components, that is, a device corresponding to the separating unit 3 of the first embodiment, the conveyance mechanism unit 73, and the driving device 300 that drives the cassette tray 206, are integrated with each other to form a lateral movement block 301.

A lateral movement rail 310 is installed in the separating region 211, and the lateral movement block 301 moves in the horizontal direction along the lateral movement rail 310. That is, a traveling motor 311 is attached to the lateral movement rail 310, and with the traveling motor 311 being driven, the lateral movement block 301 moves in the lateral direction.

As illustrated in FIG. 33, the lateral movement block 301 includes a rectangular parallelepiped main body portion 302 and an overhanging portion 303 provided above the main body portion 302.

At an upper end of the main body portion 302, the separating unit 3 is installed in a horizontal posture. The separating unit 3 includes the one-side abutment piece pair 30, the another-side abutment piece pair 31, and the lifting mechanism 32 for moving up and down the one-side abutment piece pair 30 and the another-side abutment piece pair 31, similarly to FIG. 5, FIG. 6, and FIG. 7. Further, the separating unit 3 has an approaching/separating mechanism (not shown) for moving the one-side abutment piece pair 30 and the another-side abutment piece pair 31 in the horizontal direction to cause the one-side abutment piece pair 30 and the another-side abutment piece pair 31 to approach and separate from each other. The approaching/separating mechanism (not shown) is substantially the same as the lifting mechanism 32 of the first embodiment, except that a posture of the lifting mechanism 32 is changed.

That is, the approaching/separating mechanism includes the pair of guide poles 60, the holding member 65 that holds the one-side abutment piece pair 30, and the holding member 66 that holds the another-side abutment piece pair 31.

In this embodiment, a first conveyance mechanism unit 73a and a second conveyance mechanism unit 73b are provided as a discharging device. The conveyance mechanism unit 73a moves the drug packaging strip 120 by sandwiching one side of the drug packaging strip 120 between the conveyance belt 75a stretched between the pair of pulleys 77a and 77b, and the conveyance belt 75b stretched between the pair of pulleys 78a and 78b. Tension pulleys are provided outside stretch paths of the conveyance belts 75a and 75b.

The second conveyance mechanism unit 73b also has a similar mechanism, which is a mechanism for moving the drug packaging strip 120 by sandwiching one side of the drug packaging strip 120 between a conveyance belt stretched between a pair of pulleys, and a conveyance belt stretched between a pair of pulleys.

### Driving Device 300

The overhanging portion 303 of the lateral movement block 301 includes a placement table 320 installed in the horizontal direction, and a geared motor 305 is installed on the placement table 320 via a linear movement mechanism 306. The driving device 300 includes the geared motor 305, and includes a long output shaft 321. A clutch piece 307 is provided at a distal end of the output shaft 321.

The driving device 300 is located at a position higher than the separating unit 3, and a height of the output shaft 321 of the geared motor 305 is identical to a height of the through hole 228 of the roll cassette 201 in the cassette accommodating region 210. Further, the driving device 300 is moved by the linear movement mechanism 306 in a direction of approaching and separating from the roll cassette 201.

Accordingly, when the lateral movement block 301 is moved laterally in the X-axis direction to stop the lateral movement block 301 at a position of a specific roll cassette 201, and the driving device 300 is moved toward the roll cassette 201 side (front side in the Y-axis direction) by the linear movement mechanism 306, the output shaft 321 of the geared motor 305 enters the through hole 228 of the roll cassette 201. Then, the clutch piece 307 of the driving device 305 is engaged with the clutch piece 251 of the power transmission shaft 250 in the case member 223.

Then, when the clutch piece 307 of the driving device 300 rotates, the power transmission shaft 250 in the case member 223 rotates so that the feeding device 235 and the warpage removing roller pair 240 in the roll cassette 201 are driven.

Next, a function of the separating region 211 is described.

In this embodiment, the lateral movement block 301 moves in the horizontal direction along the lateral movement rail 310, and the lateral movement block 301 is positioned below a specific roll cassette 201. That is, a lateral movement mechanism is operated by a control device (not shown) so that the lateral movement block 301 moves to a position below the specific roll cassette 201.

Then, the drug packaging strip 120 discharged from the roll cassette 201 by driving the roll cassette 201 on the upper side is drawn into the separating region 211, and the drug package 110 is separated to be discharged downward, as in the embodiment described above.

### Distributing Region 212

Next, a configuration of the distributing region 212 is described with reference to FIG. 25 and FIG. 33 to FIG. 37. The distributing region 212 is a region that performs a function of receiving the drug package 110 from the separating region 211 on the upper section, moving the drug package 110 in the lateral direction (X-axis direction) to stop the drug package 110 at a predetermined position, and inserting the drug package 110 into a compartment of the distribution box 202 located below the distributing region 212.

In the distributing region 212, a multifunctional block 401 is installed on a lateral movement rail 400. The multifunctional block 401 is formed by integrating a holding device 402, a turning mechanism 405, a release mechanism 406, and an insertion device 407 with each other. The holding device 402 receives the drug package 110 from the separating region 211 on the upper section and holds the drug package 110. The turning mechanism 405 turns the holding device 402 by 90 degrees to change a posture of the drug package 110. The release mechanism 406 releases the holding by the holding device 402. The insertion device 407 pulls out the drug package 110 from the holding device 402 to drop the drug package 110. Further, a motor 403 that is used in moving the multifunctional block 401 along the lateral movement rail 400 is installed at an end portion of the lateral movement rail 400.

The holding device 402 has a mechanism similar to that of the above-mentioned conveyance mechanism units 12 and 73, and holds the drug package 110 by sandwiching the common seal portion 125 of the drug package 110 between conveyance belts 411a and 411b. Then, under the state of holding the drug package 110, the holding device 402 is turned by 90 degrees by the turning mechanism 405.

Under this state, the multifunctional block 401 is moved in the lateral direction (X-axis direction) to stop the multifunctional block 401 at a predetermined position. Subsequently, the holding of the drug package 110 by the holding device 402 is released, and the drug package 110 is further held by the insertion device 407 to be fed downward, and the drug package 110 is placed into a predetermined compartment 203 of the distribution box 202 being on standby on the lower side. A specific structure is described below.

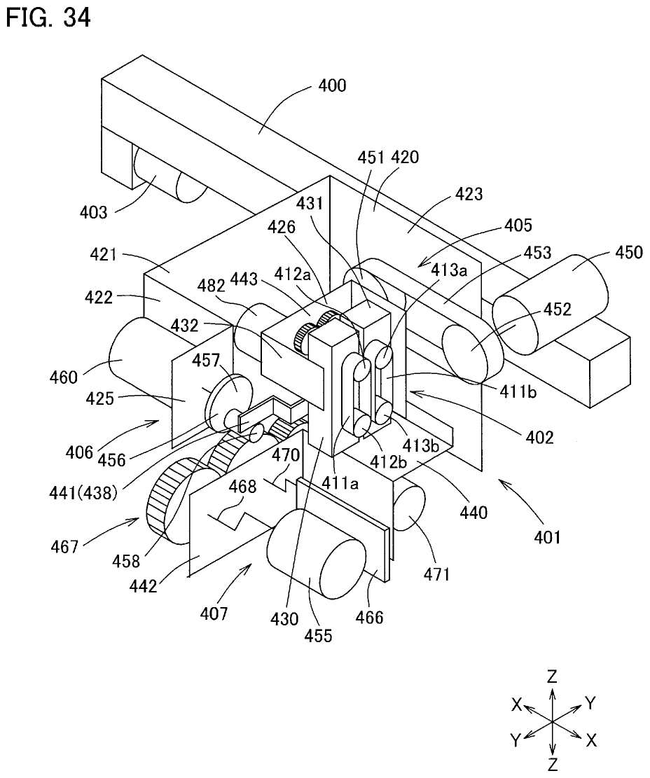

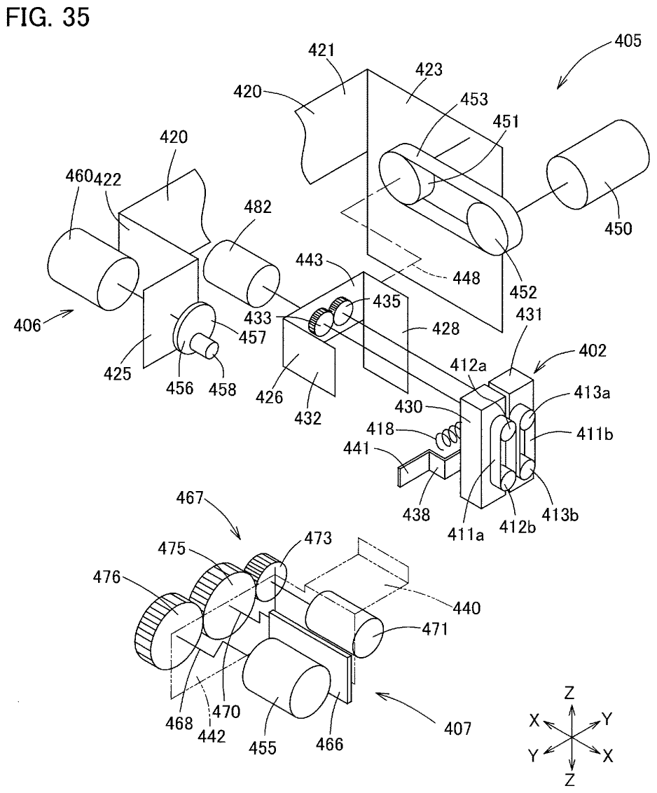

The multifunctional block 401 includes a linear motion frame 420 as illustrated in FIG. 34 and FIG. 35.

The linear motion frame 420 is engaged with the lateral movement rail 400 and is moved in a linear direction along the lateral movement rail 400 by the motor 403.

As illustrated in FIG. 34 and FIG. 35, the linear motion frame 420 includes a back plate 421, and a first side plate 422 and a second side plate 423 that are provided at end portions of the back plate 421, respectively. Further, a flange portion 425 is provided on an end surface of the first side plate 422. In this embodiment, the holding device 402 is attached via a turning frame 426 to a recessed portion surrounded by the back plate 421, the first side plate 422, and the second side plate 423 of the linear motion frame 420. Further, the insertion device 407 is arranged below the flange portion 425 of the linear motion frame 420. Further, the turning mechanism 405 for turning the turning frame 426 is provided between the second side plate 423 of the linear motion frame 420 and the turning frame 426.

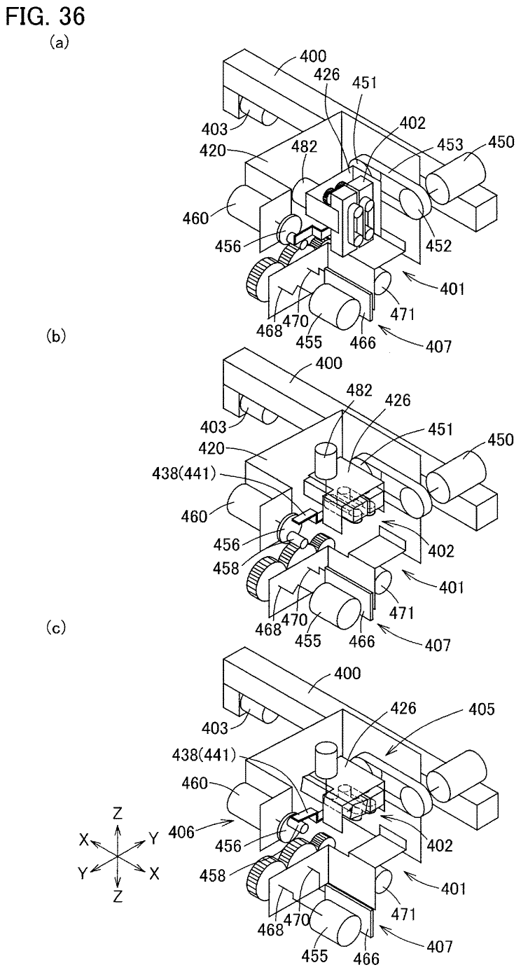

As illustrated in FIG. 34, FIG. 35, and FIG. 36, the turning frame 426 has a groove-shaped cross-section, and the above-mentioned holding device 402 is supported by the turning frame 426.

As illustrated in FIG. 34 and FIG. 35, the turning frame 426 includes a back plate 443, and a first side plate 432 and a second side plate 428 that are provided at end portions of the back plate 443, respectively.

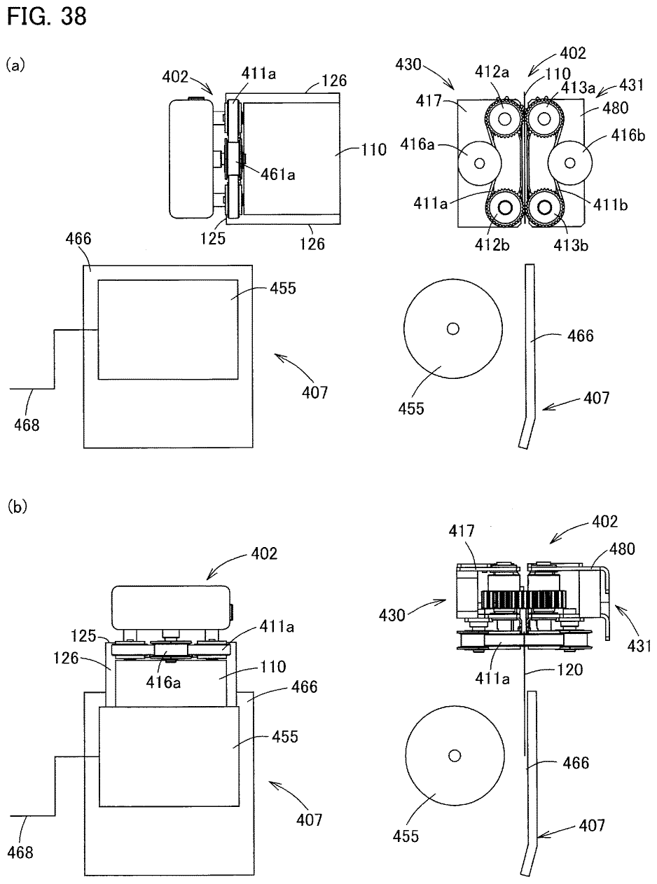

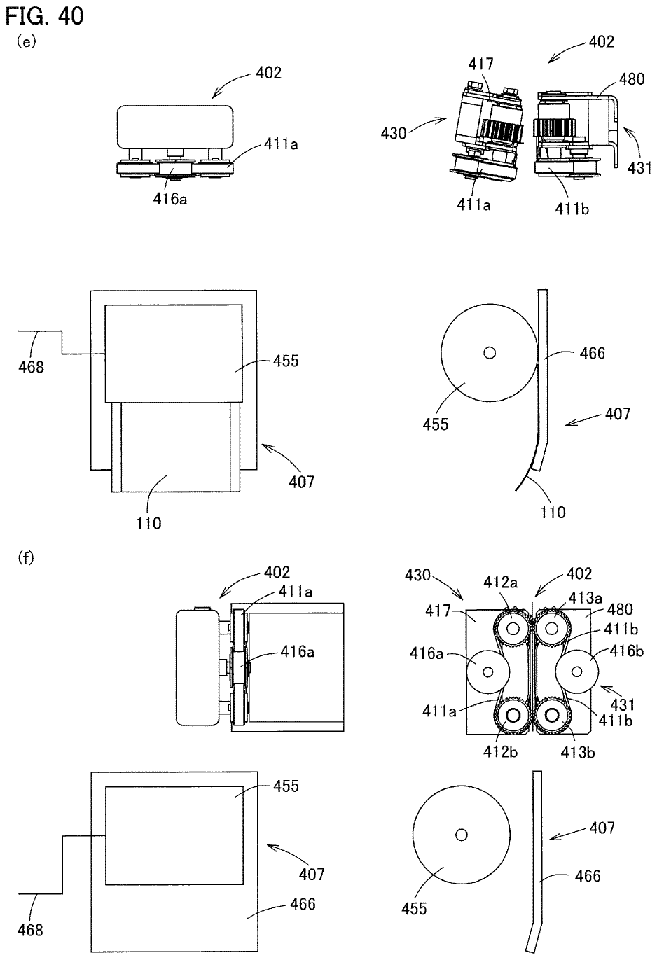

The holding device 402 has a mechanism similar to that of the above-mentioned conveyance mechanism units 12 and 73, and as illustrated in FIG. 34, FIG. 35, and FIG. 38 to FIG. 40, draws the drug package 110 into the holding device 402 by sandwiching one side of the drug package 110 between the conveyance belt 411a stretched between a pair of pulleys 412a and 412b, and the conveyance belt 411b stretched between a pair of pulleys 413a and 413b. Then, under the state of drawing the drug package 110 into the holding device 402, the holding device 402 stops the conveyance belts 411a and 411b, and as a result, an end portion of the drug package 110 is sandwiched between the conveyance belts 411a and 411b to be held. Tension pulleys 416a and 416b are provided outside stretch paths of the conveyance belts 411a and 411b as illustrated in FIG. 38 and FIG. 40, but illustration of the tension pulleys is omitted in FIG. 34 to FIG. 36 for the sake of drawing.

In this embodiment, the pair of pulleys 412a and 412b, the conveyance belt 411a, and the tension pulley 416a are unitized and attached to a movable plate 417. The pulleys 412a and 412b, the conveyance belt 411a, and the tension pulley 416a attached to the movable plate 417 are hereinafter referred to as “movable side holding unit 430.”

Further, the another pair of pulleys 413a and 413b, the conveyance belt 411b, and the tension pulley 416b are unitized and attached to a fixed plate 480. The pulleys 413a and 413b, the conveyance belt 411b, and the tension pulley 416b attached to the fixed plate 480 are hereinafter referred to as “fixed side holding unit 431.”

In this embodiment, as illustrated in FIG. 34 and FIG. 35, a geared motor 482 is provided on an outer side of the back plate 443 of the turning frame 426, and the pulley 412a on the movable side holding unit 430 side is rotated by the geared motor 482. Further, the pulley 412a of the movable side holding unit 430 and the pulley 413a of the fixed side holding unit 431 are respectively engaged with gears 433 and 435 as illustrated in FIG. 35. Accordingly, with driving of the geared motor 482, the pulleys 412a and 412b and the conveyance belt 411a of the movable side holding unit 430, and the pulleys 413a and 413b and the conveyance belt 411b of the fixed side holding unit 431 are driven.

The movable side holding unit 430 is attached to the turning frame 426 via a support member (not shown). The movable side holding unit 430 has a degree of freedom in a direction of approaching and separating from the fixed side holding unit 431. However, the movable side holding unit 430 is urged toward the fixed side holding unit 431 side by a spring 418.

In this embodiment, there is provided the release mechanism 406 that releases holding of the drug package 110 by the holding device 402 by moving the movable side holding unit 430 in a direction away from the fixed side holding unit 431.

In this embodiment, the release mechanism 406 includes a cam motor 460, a cam 456, and a drive member 438 attached to the movable side holding unit 430.

That is, the drive member 438 is attached to the movable side holding unit 430. The drive member 438 extends around an outside of the turning frame 426 and protrudes outward of the first side plate 432 thereof.

The drive member 438 has a plate shape, and a free end of the drive member 438 is bent to form an engaging portion 441. When the drive member 438 is swung, the movable side holding unit 430 moves in a direction of approaching and separating from the fixed side holding unit 431. In this embodiment, the movable side holding unit 430 is urged toward the fixed side holding unit 431 side by the spring (urging member) 418. Then, with the swinging of the drive member 438, the movable side holding unit 430 is separated from the fixed side holding unit 431.

The cam 456 is provided on the flange portion 425 of the linear motion frame 420. The cam 456 includes an engaging pin 458 provided on a surface of a rotating plate 457. The cam 456 is driven by the cam motor 460.

In this embodiment, as illustrated in FIG. 35, the turning frame 426 is rotatably supported by the second side plate 423 of the linear motion frame 420. Further, a rotation shaft 448 of the turning frame 426 protrudes outward of the second side plate 423 of the linear motion frame 420. A toothed pulley 451 is attached to the rotation shaft 448.

In this embodiment, the turning mechanism 405 for turning the turning frame 426 is provided between the second side plate 423 of the linear motion frame 420 and the turning frame 426.

That is, the turning mechanism 405 includes: a turning geared motor 450; a toothed pulley 452 attached to an output shaft of the turning geared motor 450; the toothed pulley 451 attached to the rotation shaft 448 of the turning frame 426; and a toothed belt 453 stretched between the toothed pulleys 451 and 452.

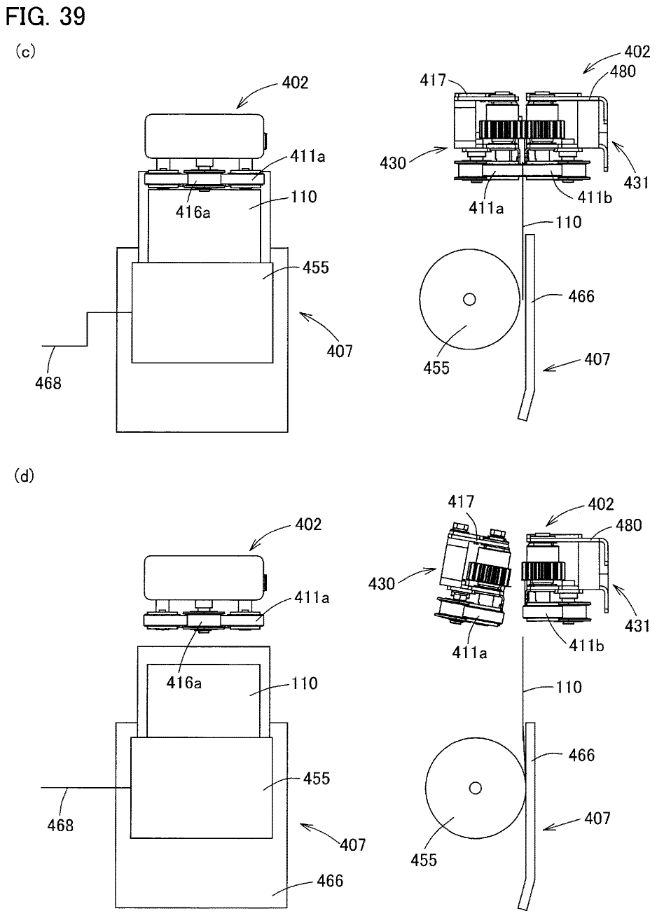

Next, functions of the holding device 402 and the turning frame 426 are described with reference to FIG. 36, FIG. 38, and FIG. 39.

FIG. 36(a) and FIG. 38(a) show a preparation stage, and the holding device 402 is in a posture in which an opening side of the turning frame 426 is directed in the lateral direction (X-axis direction).

When the turning geared motor 450 is rotated under this state, the rotational force is transmitted to the toothed pulley 451 attached to the rotation shaft 448 of the turning frame 426 via the toothed pulley 452 and the toothed belt 453, and the turning frame 426 turns about the rotation shaft 448, as illustrated in FIG. 36(b) and FIG. 38(b).

As a result, as illustrated in FIG. 36(b) and FIG. 38(b), the posture of the holding device 402, which has been vertical, is changed to a horizontal posture. That is, the holding device 402 is brought into a posture such that the opening side of the turning frame 426 is directed downward (Z-axis direction).

Further, with the change in the posture of the turning frame 426, a position of the drive member 438 changes, and the engaging portion 441 of the drive member 438 reaches the vicinity of the cam 456.

When the cam motor 460 is started under this state to turn the cam 456, the drive member 438 is engaged with the engaging pin 458 to move up so that the movable side holding unit 430 is separated from the fixed side holding unit 431 as illustrated in FIG. 39(d).

Next, the insertion device 407 is described with reference to FIG. 34 to FIG. 40.

As illustrated in FIG. 34 and FIG. 35, the insertion device 407 is fixed to the second side plate 423 of the linear motion frame 420 via a connection member 440. The connection member 440 is a complicatedly bent plate, and includes an insertion device support plate 442 standing upright in a Y direction at an end portion of the connection member 440.

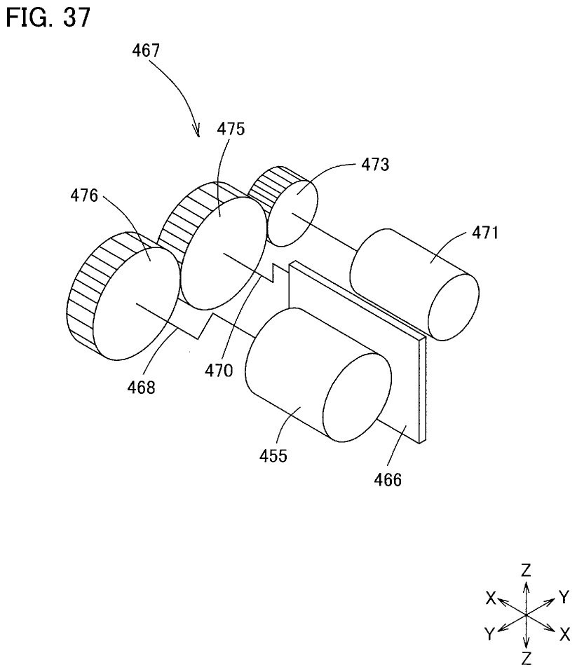

As illustrated in FIG. 34, FIG. 35, and FIG. 37, the insertion device 407 includes a turning roller 455, a backing plate member 466, and a driving device 467 that operates the backing plate member 466 and the driving device 467 in association with each other. The insertion device 407 is located below the turning frame 426.

The turning roller 455 is made of a soft material such as sponge or foamed resin, and is a roller with a slightly large diameter. Further, the turning roller 455 is longer than a length of the drug package 110. The turning roller 455 is attached to a crankshaft 468.

The backing plate member 466 is an elongated plate, is attached to a linear guide (not shown), and has a degree of freedom only in the up-down direction. A crankshaft 470 is connected to the backing plate member 466.

The driving device 467 of the insertion device 407 is formed of an insertion geared motor 471 and a three-stage gear train. That is, a drive gear 473 is attached to an output shaft of the insertion geared motor 471. In addition thereto, the driving device 467 includes: a first driven gear 475 that is engaged with the drive gear 473 and receives power transmitted from the drive gear 473; and a second driven gear 476 that is engaged with the first driven gear 475 and receives power transmitted from the first driven gear 475.

In this embodiment, the driving device 467 of the insertion device 407 is located on a back surface side of the flange portion 425 of the linear motion frame 420, and the turning roller 455 and the backing plate member 466 are located on a front surface side of the flange portion 425.

Then, the crankshaft 468 on the turning roller 455 side is attached to the second driven gear 476. Further, the crankshaft 470 on the backing plate member 466 side is connected to the first driven gear 475.

Accordingly, when the insertion geared motor 471 of the driving device 467 is rotated, the first driven gear 475 and the second driven gear 476 rotate so that the crankshaft 468 on the turning roller 455 side and the crankshaft 470 on the backing plate member 466 side rotate synchronously. As a result, the turning roller 455 turns, and the backing plate member 466 moves up and down.

### Distribution Box Installation Region 213

Next, the distribution box installation region 213 is described with reference to FIG. 24 and FIG. 25. The distribution box installation region 213 is a portion in which the distribution box 202 is to be installed. The distribution box installation region 213 includes moving means 500 for moving the distribution box 202 in a front-back direction (Y-axis direction).

The moving means 500 includes toothed belts 502a and 502b installed in parallel with each other with a space therebetween. The toothed belts 502a and 502b are respectively stretched between a pair of pulleys 503a and 503b and a pair of pulleys 505a and 505b. The pulleys 502 and 503 located at positions facing each other are connected to each other by common shafts, and the pulleys 502 and 503 rotate synchronously. Further, the moving means 500 is driven by a geared motor 515. The geared motor 515 is pulse-controlled by a control device (not shown), and thus can be rotated by a certain number of rotations.

Accordingly, the distribution box 202 on the moving means 500 can be moved to be stopped at a predetermined position in the front-back direction (Y-axis direction).

The moving means 500 includes a distribution box fixing member (not shown), and hence the distribution box 202 can be fixed at a predetermined position on the moving means 500.

The distribution box 202 of this embodiment is a box that is substantially rectangular, has a shallow depth, and has an open upper surface.

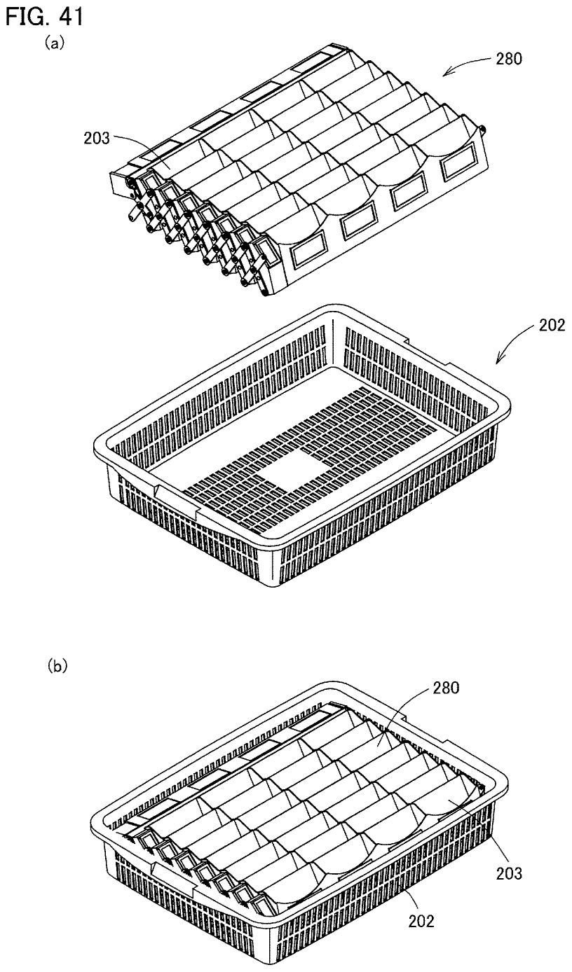

In this embodiment, as illustrated in FIG. 41, a drug setting tool 280 is inserted into the distribution box 202, and the distribution box 202 is partitioned into a plurality of compartments 203 in a matrix pattern by the drug setting tool 280.

The drug setting tool 280 is a drug setting tool as disclosed in JP 2024-11984 A, and is a foldable medication calendar. The drug setting tool 280 can be extended to take a form of a wall-mounted medication calendar, and can be contracted to be placed into the distribution box 202 as illustrated in FIG. 41.

The drug setting tool 280 of this embodiment is used in sorting drugs to be taken by one patient for one week, and has four compartments of “for morning,” “for noon,” “for night,” and “before bedtime” in a horizontal direction (X-axis direction). Further, the drug setting tool 280 has seven compartments for Sunday, Monday, Tuesday, Wednesday, Thursday, Friday, and Saturday, in a vertical direction (Y-axis direction).

In this embodiment, after a predetermined drug package 110 is accommodated in each compartment 203 of the drug setting tool 280, the drug setting tool 280 is taken out from the distribution box 202 to be shipped to a patient.

In this embodiment, the compartment 203 of the distribution box 202 is surrounded by a bottom surface and four vertical walls 510, 511, 512, and 513. In this embodiment, among the four vertical walls 510, 511, 512, and 513, the vertical wall 511 provided on a back side in a Y direction is an inclined wall.

The type of the distribution box 202 and the type of the drug setting tool 280 are not limited, and may be for one month, or may be for a plurality of persons.

The distribution box 202 adopted in this embodiment includes one vertical wall 511 forming the compartment 203, which is an inclined wall.

According to this configuration, the drug package 110 is accommodated under a state of leaning against the inclined wall, and as a result, a posture of the drug package 110 in each compartment 203 is unified.

A plurality of drug packages 110 may be inserted into one compartment, and in such a case, it is possible to prevent a later-inserted drug package 110 from colliding with a previously accommodated drug package 110. That is, according to this embodiment, the previously accommodated drug package 110 always leans against the inclined wall and is inclined to one side, and hence a leading edge of a subsequent drug package 110 does not collide with a trailing edge of the preceding drug package.

Of course, inner walls of each compartment may all be vertical.

### Function of Drug Package Separating Apparatus 200

Next, a function of the drug package separating apparatus 200 is described.

In the drug package separating apparatus 200 of this embodiment, as a preparation stage, the reel 160 of the drug packaging strip 120 is mounted on the roll cassette 201 as illustrated in FIG. 29. Then, an end portion of the drug packaging strip 120 is pulled out from the reel 160 mounted on the roll cassette 201, and one side of the drug packaging strip 120 is sandwiched between the conveyance belts 16a and 16b of the feeding device 235. Specifically, the seal portion 130 of the drug packaging strip 120 is sandwiched between the conveyance belts 16a and 16b.

A plurality of roll cassettes 201 in this state are mounted on the cassette tray 206.

Further, the distribution box 202 is installed in the distribution box installation region 213.

When preparation has been completed, a switch (not shown) is operated to operate the drug package separating apparatus 200. The following steps are automatically performed by a control device (not shown).

First, the traveling motor 311 (FIG. 25) of the lateral movement rail 310 in the separating region 211 is driven, and the lateral movement block 301 is moved in the lateral direction (X-axis direction) to move the separating unit 3 and the like to positions below the cassette tray 206 in which the drug packages 110 for a specific patient have been accommodated.

Along with the movement of the lateral movement block 301, the driving device 300 (FIG. 27 and FIG. 33) moves to a side surface of the cassette tray 206. Subsequently, the linear movement mechanism 306 of the placement table 320 provided on the overhanging portion 303 (FIG. 27 and FIG. 33) of the lateral movement block 301 is driven to move the driving device 300 closer to the roll cassette 201. The clutch piece 307 of the driving device 300 is engaged with the clutch piece 251 of the power transmission shaft 250 in the case member 223.

Under this state, the geared motor 305 of the driving device 300 (FIG. 27 and FIG. 33) rotates so that the feeding device 235 and the warpage removing roller pair 240 in the roll cassette 201 are driven. As a result, the drug packaging strip 120 is fed out from the reel 160 to be sent to the warpage removing roller pair 240 on the downstream side. As illustrated in FIG. 30 to FIG. 32, in the warpage removing roller pair 240, the drug packaging strip is sandwiched between the engaging portion 243 of the annularly-protruding roller 241 and the grooved roller 242 so that the crease 260 being continuous in the longitudinal direction is formed on the seal portion 130 of the drug packaging strip 120.

The drug packaging strip 120 wound in a roll shape may have warpage. In this embodiment, the annularly-protruding roller 241 is put on an outer side of a warp of the drug packaging strip 120, and the grooved roller 242 having a recess is put on an inner side of the warp. With the drug packaging strip 120 being caused to pass through the warpage removing roller pair 240, the drug packaging strip 120 is bent in a direction opposite to the warp, and thus the warpage of the drug packaging strip 120 is removed, resulting in a straight shape.

That is, the warpage removing roller pair 240 of this embodiment is used in removing warpage of the drug packaging strip 120, and with the drug packaging strip 120 being caused to pass through the warpage removing roller pair 240, the warpage of the drug packaging strip 120 is removed so that the drug packaging strip has a straight shape.

In this embodiment, the warp of the drug packaging strip 120 is eliminated by causing the drug packaging strip 120 to pass through the warpage removing roller pair 240. That is, in this embodiment, a method is adopted in which curling of the drug packaging strip 120 is eliminated while feeding the drug packaging strip 120 to the warpage removing roller pair 240. In this embodiment, the curling is continuously removed by causing the drug packaging strip 120 to pass only once between the annularly-protruding roller 241 and the grooved roller 242, and hence it is required that the warpage removing roller pair 240 and the drug packaging strip 120 be brought into surface contact with each other, and in addition, it is desired that a contact area between the warpage removing roller pair 240 and the drug packaging strip 120 be large. Accordingly, it is desired that a protruding portion of the annularly-protruding roller 241 protrude greatly, and a groove of the grooved roller 242 be deep.

In this embodiment, the warp can be eliminated by continuously feeding out the drug packaging strip 120, but when it is permissible to intermittently feed the drug packaging strip 120, the feeding of the drug packaging strip 120 may be temporarily stopped, the drug packaging strip 120 may be fed out by a predetermined length, and the warp may be eliminated by ironing with a spatula-like object. In this case, a member used for ironing may have a planar shape, but it is desired that the member have a curved surface.

In this embodiment, the drug packaging strip 120 that has passed through the warpage removing roller pair 240 to have the crease 260 made thereon is discharged from the cassette tray 206 to be suspended.

Here, in the separating region 211, the separating unit 3 is on standby directly below the roll cassette 201 as illustrated in FIG. 24 and FIG. 25, and the drug packaging strip 120 moving down from the roll cassette 201 enters the separating unit 3. Then, the drug packaging strip 120 is separated into individual drug packages 110 by the separating unit 3 to be discharged downward through the first conveyance mechanism unit 73a and the second conveyance mechanism unit 73b.

Here, a posture of the drug package 110 is a vertical posture as illustrated in FIG. 38(a), a separation line (perforation 126) is in a horizontal posture, and the common seal portion 125 is a vertical side.

In the distributing region 212, in parallel with the above-mentioned operation, the lateral movement rail 400 is driven to move the multifunctional block 401, and the multifunctional block 401 is put on standby at a position directly below the main body portion 302 of the lateral movement block 301.

That is, in the distributing region 212 of this embodiment, the lateral movement rail 400 is laid in the lateral direction (X direction), and the linear motion frame 420 of the multifunctional block 401 is engaged with the lateral movement rail 400. Accordingly, the multifunctional block 401 can be moved in the lateral direction (X direction) along the lateral movement rail 400.

As illustrated in FIG. 36(a), the multifunctional block 401 is on standby in a posture in which the opening side of the turning frame 426 of the multifunctional block 401 is directed in the lateral direction (X-axis direction). Accordingly, as illustrated in FIG. 36(a), the conveyance belts 411a and 411b extend in the up-down direction (Z-axis direction), and the conveyance belts 411a and 411b travel in the up-down direction (Z-axis direction). Under this state, the movable side holding unit 430 is urged toward the fixed side holding unit 431 side by urging means (not shown).

The drug packages 110 are supplied one by one from the separating region 211 on the upper side to the multifunctional block 401 on standby under this state.

At a timing when the drug package 110 is discharged from the separating region 211, the geared motor 482 is started so that the holding device 402 of the multifunctional block 401 is started.

As a result, the drug package 110 is drawn into the holding device 402 by sandwiching one side of the drug package 110 between the conveyance belt 411a stretched between the pair of pulleys 412a and 412b, and the conveyance belt 411b stretched between the pair of pulleys 413a and 413b. Then, under a state in which the drug package 110 has been completely drawn into the holding device 402, the conveyance belts 411a and 411b are stopped.

As described above, the drug package 110 discharged from the separating region 211 is in a vertical posture, the separation line (perforation 126) is in a horizontal posture, and the common seal portion 125 is a vertical side. In the multifunctional block 401, the conveyance belts 411a and 411b of the holding device 402 extend in the up-down direction (Z-axis direction) and are in a posture of traveling in the up-down direction (Z-axis direction). Accordingly, in the drug package 110, the common seal portion 125, which is a vertical side, is sandwiched between the conveyance belts 411a and 411b, and like a flag, one vertical side (common seal portion 125) is held, and another vertical side (folded side) is a free end. Further, upper and lower separation lines (perforations 126) are also free.

When the drug package 110 is completely held by the holding device 402, the conveyance belts 411a and 411b are stopped, and the drug package 110 is supported in a flag-like posture as illustrated in FIG. 38(a).

Then, when it is confirmed by a sensor (not shown) that the drug package 110 has been completely held by the holding device 402, the turning mechanism 405 is started so that the holding device 402 turns by 90 degrees about an axis in the Y direction, resulting in that the holding device 402, which has been previously oriented in a vertical direction, changes its posture to a horizontal posture as illustrated in FIG. 38(b).

That is, the holding device 402 is attached to the turning frame 426, and the turning frame 426 is rotatably supported by the second side plate 423 of the linear motion frame 420. Further, the toothed pulley 451 is provided on the rotation shaft 448 of the turning frame 426, and the toothed belt 453 is stretched between the toothed pulley 451 and the toothed pulley 452 provided on the turning geared motor 450.

In this embodiment, when it is confirmed by a sensor (not shown) that the drug package 110 has been completely held by the holding device 402, the turning geared motor 450 is started to turn the turning frame 426 by 90 degrees so that the posture of the holding device 402, which has been oriented in a vertical direction, is changed to a horizontal posture. As a result, the posture of the drug package 110 held by the holding device 402 is changed.

That is, as illustrated in FIG. 38(b), the common seal portion 125 is present on an upper side and in a horizontal posture facing the X-axis direction, and the separation line (perforation 126) becomes a vertical side facing up and down.

Then, as a next stage, under a state in which the common seal portion 125 of the drug package 110 is held as an upper side, the multifunctional block 401 is moved in the lateral direction to move the drug package 110. That is, the multifunctional block 401 is moved to a position of a specific vertical row of the distribution box 202, for example, to move the drug package 110 to a position above a “for morning” row of the distribution box 202.

In this embodiment, the multifunctional block 401 is installed on the lateral movement rail 400, and the multifunctional block 401 includes, in addition to the holding device 402, the turning mechanism 405 for turning the holding device 402 by 90 degrees to change the posture of the drug package 110, the release mechanism 406 for releasing the holding by the holding device 402, and the insertion device 407 that pulls out the drug package 110 from the holding device 402 to drop the drug package 110.

Accordingly, in this embodiment, the release mechanism 406 and the insertion device 407 also move together with the drug package 110.

Then, when the drug package 110 reaches, for example, a position above the “for morning” row of the distribution box 202, the release mechanism 406 and the insertion device 407 operate.

That is, in a preceding stage, the turning frame 426 turns so that the fixed side holding unit 431 and the movable side holding unit 430 are brought into a posture facing the horizontal direction. Accordingly, the drive member 438 attached to the movable side holding unit 430 also turns.

Meanwhile, the cam 456 is attached to the flange portion 425 of the linear motion frame 420, and the posture of the cam 456 does not change.

In this embodiment, with turning of the turning frame 426, the position of the drive member 438 attached to the turning frame 426 changes, and the engaging portion 441 of the drive member 438 enters a turn track of the engaging pin 458 of the cam 456 as illustrated in FIG. 36(b). In this embodiment, when the drug package 110 reaches a position above the “for morning” row of the distribution box 202, the cam motor 460 is started to turn the cam 456 as illustrated in FIG. 36(c) so that the engaging portion 441 of the drive member 438 is moved. Accordingly, the drive member 438 moves up so that the movable side holding unit 430 is separated from the fixed side holding unit 431, as illustrated in FIG. 39(c). As a result, the holding by the holding device 402 is released, and the drug package 110 is opened.

Further, in parallel with the foregoing, the insertion geared motor 471 of the insertion device 407 is driven. As a result, as illustrated in FIG. 36(c), FIG. 39(d), and FIG. 40(e), the crankshaft 468 on the turning roller 455 side and the crankshaft 470 on the backing plate member 466 side rotate synchronously so that the turning roller 455 turns, and the backing plate member 466 moves down.

With the turning of the turning roller 455, the turning roller 455 moves toward the backing plate member 466 side as illustrated in FIG. 39(c) and FIG. 39(d), and FIG. 40(e). Then, when the turning roller 455 further turns, the turning roller 455 moves in a direction away from the backing plate member 466 as illustrated in FIG. 40(f). As described above, the crankshaft 468 on the turning roller 455 side and the crankshaft 470 on the backing plate member 466 side rotate synchronously, and hence, when the turning roller 455 moves toward the backing plate member 466 side, the turning roller 455 is brought into contact with the backing plate member 466, and the turning roller 455 and the backing plate member 466 move downward under a state of being in contact with each other.

Accordingly, the drug package 110 released from the holding by the holding device 402 is moved downward under a state of being held by the turning roller 455 and the backing plate member 466, to be inserted into the compartment 203.

Then, the turning roller 455 is separated from the backing plate member 466, and the drug package 110 enters the “for morning” compartment 203 in a Sunday row of the lower distribution box 202.

After that, this operation is repeated, and the drug package 110 is inserted into a “for noon” compartment in the Sunday row of the distribution box 202, then the drug package 110 is inserted into a “for night” compartment in the Sunday row, and in addition, the drug package 110 is inserted into a “for before bedtime” compartment in the Sunday row.

When all the compartments in the Sunday row are filled, the moving means 500 is driven to move the distribution box 202 in the Y direction by one compartment.

Then, the same operation as that described above is repeated, and the drug packages 110 are sequentially placed into a Monday row of the distribution box 202.

In the embodiment described above, the holding device 402 provided in the distributing region 212 is moved linearly in one direction, and the distribution box 202 provided in the distribution box installation region 213 is moved linearly in another direction, to thereby relatively move the drug package 110 in a plane to insert the drug package 110 into a desired compartment 203.

The present invention is not limited to this configuration, and the holding device 402 may be moved two-dimensionally or three-dimensionally to insert the drug package 110 into the compartment 203 of the stationary distribution box 202. Conversely, the holding device 402 may be left at a specific position, and the distribution box 202 may be moved in a plane to insert the drug package 110 into the compartment 203 of the distribution box 202.

The insertion device 407 adopted in this embodiment uses a crankshaft, but the drug package 110 may be inserted into the compartment 203 using a linear guide or a robot hand. Alternatively, the holding of the drug package 110 may be simply released to allow the drug package 110 to drop naturally so that the drug package 110 is placed into the compartment 203.

In the case of holding the drug package 110 using a robot hand, the common seal portion 125 may be held similarly to the embodiment described above, but sides of portions of right and left separation lines (perforations 126) may be held.

For example, warpage of the drug packaging strip 120 can be corrected by sandwiching both sides of the drug package 110 from front and back sides.

An air gun that blows air to the compartment 203 of the distribution box 202 may be provided. For example, an air gun is installed in the vicinity of the holding device 402, and when an additional drug package 110 is put into the compartment 203, air is blown to a preceding drug package 110 to move the drug package 110 toward a wall side.

The drug package separating apparatus 200 described above has the following characteristic configurations.

The drug package separating apparatus 200 is a drug package separating apparatus in which a pair of abutment portions are arranged in a height direction, and a force with which the pressing means presses the abutment pieces causes the abutment pieces to move in the up-down direction or change postures of the abutment pieces so that a distance between the abutment portions is increased in the up-down direction.

The drug package separating apparatus 200 includes a reel accommodating region in which a plurality of reels 160, on each of which a drug packaging strip 120 has been wound, are installed, a separating unit 3 that is provided with abutment portions and separates a drug package from the drug packaging strip 120 supplied from the reel 160, and conveyance means for conveying the drug package separated by the separating unit 3. The reel accommodating region is provided above the separating unit 3. The conveyance means is provided below the separating unit 3.

In the drug package separating apparatus 200, the separating unit is movable, and can be moved to a position below any appropriate reel 160.

The drug package separating apparatus 200 includes a detachable roll cassette. The roll cassette includes, in a case, a reel attachment shaft 233 on which the reel 160 having the drug packaging strip 120 wound thereon is mounted, and a feeding device incorporated in the case. The feeding device is driven by receiving power transmitted from the outside of the case.

In the drug package separating apparatus 200, the conveyance means holds the drug package to move linearly, and releases the drug package at a predetermined position.

The drug package separating apparatus 200 includes a holding member for holding one side of the drug package, and posture changing means for changing a posture of the holding member. The drug package separating apparatus 200 holds the drug package in a vertical posture by the holding member, and then changes the posture of the drug package to a horizontal posture by the posture changing means.

The drug package separating apparatus 200 includes insertion means for moving the drug package while sandwiching a front surface and a back surface of the drug package.

The insertion means of the drug package separating apparatus 200 includes a roll attached to a crankshaft and a backing member that moves in the up-down direction.

The drug package separating apparatus 200 includes warpage removing means for continuously bending a part of the drug packaging strip 120.

The warpage removing means of the drug package separating apparatus 200 includes a roller having a protruding ridge on a peripheral surface thereof, and a roller having a recessed groove in a peripheral surface thereof.

1. A drug package separating apparatus, which is configured to individually separate drug packages from a drug packaging strip in which the drug packages are connected in a band shape,
the drug package separating apparatus comprising:
a pair of abutment portions that are brought into contact with the same surface of the drug packaging strip;
an abutment piece having one of the abutment portions; and
pressing means for pressing the abutment piece against the drug packaging strip,
wherein a force with which the pressing means presses the abutment piece causes the abutment piece to move or change a posture of the abutment piece so that a distance between the abutment portions is increased.

2. The drug package separating apparatus according to claim 1, further comprising a pair of the abutment pieces,
wherein, when the pair of abutment pieces are pressed against the drug packaging strip by the pressing means, the pair of abutment pieces move or change the postures of the pair of abutment pieces so that the distance between the abutment portions is increased.

3. The drug package separating apparatus according to claim 1, further comprising:
a pair of abutment pieces having the abutment portions, the abutment portions being urged by an elastic member in a direction of approaching each other; and
pressing means for pressing the abutment pieces against the drug packaging strip,
wherein a force with which the pressing means presses the abutment pieces causes the abutment pieces to move or change the postures of the abutment pieces against the elastic member so that the distance between the abutment portions is increased.

4.-6. (canceled)

717. The drug package separating apparatus according to claim 1, wherein the abutment portions each have a certain length, a distance between the abutment portions at normal time and/or a distance between the abutment portions at the time when the distance has been increased is narrow on one end side and wide on another end side, and a protruding piece is provided on a side on which the distance is narrow.

8. (canceled)

9. The drug package separating apparatus according to claim 1, further comprising:
a separating unit and a feeding device, the separating unit including the pair of abutment portions, the feeding device being configured to move the drug packaging strip toward the separating unit; and
retaining means for retaining the drug packaging strip, the retaining means being provided on an upstream side of the separating unit.

10. The drug package separating apparatus according to claim 1,
wherein the drug packaging strip has a separation line with low strength, and the drug packages are allowed to be individually separated along the separation line, and wherein the drug package separating apparatus further comprises a feeding device, and the feeding device is configured to move the drug packaging strip so that a position of the separation line matches a position between the pair of abutment portions.

11. The drug package separating apparatus according to claim 1, further comprising a protruding piece that is brought into contact with the drug packaging strip,
wherein the protruding piece is configured to urge a part of the drug packaging strip.

12. The drug package separating apparatus according to claim 11, wherein a cut is formed in a part of the drug packaging strip by the protruding piece.

13.-15. (canceled)

16. The drug package separating apparatus according to claim 11, wherein the drug packaging strip includes:
a plurality of accommodating portions, each of which is configured to accommodate a drug, and which are continuously provided;
a seal portion including a separation line, which is formed between the accommodating portions, the separation line extending in a width direction of the drug packaging strip; and
a seal portion being free of the separation line, which is formed in the vicinity of an end portion in the width direction of the drug packaging strip, and
wherein the protruding piece is provided at a position at which the protruding piece is brought into contact with at least a part of the seal portion.

17. The drug package separating apparatus according to claim 1, further comprising:
a reel accommodating region in which a plurality of reels, on each of which a drug packaging strip has been wound, are allowed to be installed;
a separating unit, which is provided with abutment portions, and is configured to separate a drug package from the drug packaging strip supplied from the reel; and
conveyance means for conveying the drug package separated by the separating unit,
wherein the reel accommodating region is provided above the separating unit, and the conveyance means is provided below the separating unit.

18. The drug package separating apparatus according to claim 17, wherein the separating unit is movable, and is allowed to move to a lower side of any appropriate reel.

19. The drug package separating apparatus according to claim 17, wherein the conveyance means holds the drug package to move linearly, and releases the drug package at a predetermined position.

20. The drug package separating apparatus according to claim 17, further comprising:
a holding member configured to hold one side of the drug package; and
posture changing means for changing a posture of the holding member,
wherein the drug package is held in a vertical posture by the holding member, and then the posture of the drug package is changed to a horizontal posture by the posture changing means.

21. The drug package separating apparatus according to claim 1, further comprising warpage removing means for continuously bending a part of the drug packaging strip.

22. The drug package separating apparatus according to claim 21, wherein the warpage removing means includes:
a roller having a protruding ridge on a peripheral surface thereof; and
a roller having a recessed groove in a peripheral surface thereof.

23. The drug package separating apparatus according to claim 16, further comprising:
a reel accommodating region in which a plurality of reels, on each of which a drug packaging strip has been wound, are allowed to be installed;
a separating unit, which is provided with abutment portions, and is configured to separate a drug package from the drug packaging strip supplied from the reel; and
conveyance means for conveying the drug package separated by the separating unit,
wherein the reel accommodating region is provided above the separating unit, and the conveyance means is provided below the separating unit.

24. The drug package separating apparatus according to claim 23, wherein the separating unit is movable, and is allowed to move to a lower side of any appropriate reel.

25. The drug package separating apparatus according to claim 23, wherein the conveyance means holds the drug package to move linearly, and releases the drug package at a predetermined position.

26. The drug package separating apparatus according to claim 23, further comprising:
a holding member configured to hold one side of the drug package; and
posture changing means for changing a posture of the holding member,
wherein the drug package is held in a vertical posture by the holding member, and then the posture of the drug package is changed to a horizontal posture by the posture changing means.
